(19) United States
(12) Patent Application Publication
(10) Pub. No.: US 2022/0150019 A1
(43) Pub. Date: May 12, 2022

(54) INDICATING DMRS PORTS FOR CODEWORDS

(71) Applicant: LENOVO (BEIJING) LIMITED, Beijing (CN)

(72) Inventors: Lingling Xiao, Beijing (CN); Bingchao Liu, Beijing (CN); Chenxi Zhu, Beijing (CN); Wei Ling, Beijing (CN)

(21) Appl. No.: 17/431,102

(22) PCT Filed: Feb. 15, 2019
(86) PCT No.: PCT/CN2019/075233

§ 371 Date: Aug. 13, 2021

(51) Int. Cl. H04L 5/00; H04W 72/04

(52) U.S. Cl. CPC H04L 5/0051; H04L 5/0016; H04B 7/0691; H04L 5/0094; H04W 72/042; H04L 5/0053

(57) ABSTRACT

Apparatuses, methods, and systems are disclosed for indicating DMRS ports for codewords. One method (500) includes transmitting (502) downlink control information. The downlink control information includes first information used to indicate a plurality of demodulation reference signal ports for transmitting a plurality of codewords, receiving the plurality of codewords, or a combination thereof. The method (500) includes transmitting (504) second information indicating a plurality of reference signals for transmitting the plurality of codewords, receiving the plurality of codewords, or a combination thereof.

### FIELD

The subject matter disclosed herein relates generally to wireless communications and more particularly relates to indicating DMRS ports for codewords.

### BACKGROUND

The following abbreviations are herewith defined, at least some of which are referred to within the following description: Third Generation Partnership Project (“3GPP”), 5G QoS Indicator (“5QI”), Acknowledge Mode (“AM”), Backhaul (“BH”), Broadcast Multicast (“BM”), Buffer Occupancy (“BO”), Base Station (“BS”), Buffer Status Report (“BSR”), Bandwidth (“BW”), Bandwidth Part (“BWP”), Component Carrier (“CC”), Code Division Multiplexing (“CDM”), Control Element (“CE”), Coordinated Multipoint (“CoMP”), Categories of Requirements (“CoR”), Control Plane (“CP”), CSI-RS Resource Indicator (“CRI”), Cell RNTI (“C-RNTI”), Channel State Information (“CSI”), Channel Quality Indicator (“CQI”), Central Unit (“CU”), Codeword (“CW”), Downlink Control Information (“DCI”), Downlink (“DL”), Demodulation Reference Signal (“DMRS” or “DM-RS”), Data Radio Bearer (“DRB”), Dedicated Short-Range Communications (“DSRC”), Distributed Unit (“DU”), Enhanced Mobile Broadband (“eMBB”), Evolved Node B (“eNB”), Enhanced Subscriber Identification Module (“eSIM”), Enhanced (“E”), Frequency Division Duplex (“FDD”), Frequency Division Multiple Access (“FDMA”), Frequency Range (“FR”), 450 MHz-6000 MHz (“FR1”), 24250 MHz-52600 MHz (“FR2”), Hybrid Automatic Repeat Request (“HARQ”), Integrated Access Backhaul (“IAB”), Identity or Identifier or Identification (“ID”), Interference Measurement (“IM”), International Mobile Subscriber Identity (“IMSI”), Internet-of-Things (“IoT”), Internet Protocol (“IP”), Joint Transmission (“JT”), Level 1 (“L1”), Logical Channel (“LCH”), Logical Channel Group (“LCG”), Logical Channel ID (“LCID”), Logical Channel Prioritization (“LCP”), Long Term Evolution (“LTE”), Levels of Automation (“LoA”), Medium Access Control (“MAC”), Modulation Coding Scheme (“MCS”), Multiple Input Multiple Output (“MIMO”), Mobile-Termination (“MT”), Machine Type Communication (“MTC”), Multi-User (“MU”), Multi-User MIMO (“MU-MIMO”), Negative-Acknowledgment (“NACK”) or (“NAK”), Next Generation (“NG”), Next Generation Node B (“gNB”), New Radio (“NR”), Non-Zero Power (“NZP”), Orthogonal Frequency Division Multiplexing (“OFDM”), Peak-to-Average Power Ratio (“PAPR”), Physical Broadcast Channel (“PBCH”), Physical Downlink Control Channel (“PDCCH”), Physical Downlink Shared Channel (“PDSCH”), Policy Control Function (“PCF”), Packet Data Convergence Protocol (“PDCP”), Packet Data Network (“PDN”), Protocol Data Unit (“PDU”), Public Land Mobile Network (“PLMN”), Precoding Matrix Indicator (“PMI”), ProSe Per Packet Priority (“PPPP”), ProSe Per Packet Reliability (“PPPR”), Physical Resource Block (“PRB”), Packet Switched (“PS”), Physical Sidelink Control Channel (“PSCCH”), Physical Sidelink Shared Channel (“PSSCH”), Phase Tracking RS (“PTRS” or “PT-RS”), Physical Uplink Shared Channel (“PUSCH”), Quasi Co-Located (“QCL”), Quality of Service (“QoS”), Random Access Channel (“RACH”), Radio Access Network (“RAN”), Radio Access Technology (“RAT”), Resource Element (“RE”), Rank Indicator (“RI”), Radio Link Control (“RLC”), Radio Link Failure (“RLF”), Radio Network Temporary Identifier (“RNTI”), Resource Pool (“RP”), Radio Resource Control (“RRC”), Reference Signal (“RS”), Reference Signal Received Power (“RSRP”), Reference Signal Received Quality (“RSRQ”), Receive (“RX”), Secondary Cell (“SCell”), Sub Carrier Spacing (“SCS”), Service Data Unit (“SDU”), Subscriber Identity Module (“SIM”), Signal-to-Interference and Noise Ratio (“SINR”), Sidelink (“SL”), Sequence Number (“SN”), Scheduling Request (“SR”), SRS Resource Indicator (“SRI”), Sounding Reference Signal (“SRS”), Synchronization Signal (“SS”), SS/PBCH Block (“SSB”), Transmission Control Information (“TCI”), Time Division Duplex (“TDD”), Temporary Mobile Subscriber Identity (“TMSI”), Transmitted Precoding Matrix Indicator (“TPMI”), Transmission Reception Point (“TRP”), Transmit (“TX”), User Entity/Equipment (Mobile Terminal) (“UE”), Universal Integrated Circuit Card (“UICC”), Uplink (“UL”), Unacknowledged Mode (“UM”), Universal Mobile Telecommunications System (“UMTS”), User Plane (“UP”), Universal Subscriber Identity Module (“USIM”), Universal Terrestrial Radio Access Network (“UTRAN”), Vehicle to Everything (“V2X”), Voice Over IP (“VoIP”), Visited Public Land Mobile Network (“VPLMN”), Vehicle RNTI (“V-RNTI”), Worldwide Interoperability for Microwave Access (“WiMAX”), and Zero Power (“ZP”). As used herein, “HARQ-ACK” may represent collectively the Positive Acknowledge (“ACK”) and the Negative Acknowledge (“NAK”). ACK means that a TB is correctly received while NAK means a TB is erroneously received.

In certain wireless communications networks, multiple codewords may be used. In such networks, a device may not know what DMRS ports correspond to the multiple codewords.

### BRIEF SUMMARY

Methods for indicating DMRS ports for codewords are disclosed. Apparatuses and systems also perform the functions of the apparatus. In one embodiment, the method includes transmitting downlink control information. In such an embodiment, the downlink control information includes first information used to indicate a plurality of demodulation reference signal ports for transmitting a plurality of codewords, receiving the plurality of codewords, or a combination thereof. In certain embodiments, the method includes transmitting second information indicating a plurality of reference signals for transmitting the plurality of codewords, receiving the plurality of codewords, or a combination thereof.

An apparatus for indicating DMRS ports for codewords, in one embodiment, includes a transmitter that: transmits downlink control information, wherein the downlink control information comprises first information used to indicate a plurality of demodulation reference signal ports for transmitting a plurality of codewords, receiving the plurality of codewords, or a combination thereof; and transmits second information indicating a plurality of reference signals for transmitting the plurality of codewords, receiving the plurality of codewords, or a combination thereof.

In one embodiment, a method for receiving information indicating DMRS ports for codewords includes receiving downlink control information. In such an embodiment, the downlink control information includes first information used to indicate a plurality of demodulation reference signal ports for transmitting a plurality of codewords, receiving the plurality of codewords, or a combination thereof. In certain embodiments, the method includes determining a set of demodulation reference signal ports of the plurality of demodulation reference signal ports for each codeword of the plurality of codewords based on a demodulation reference signal group configuration. In some embodiments, the method includes receiving second information indicating a plurality of reference signals for transmitting the plurality of codewords, receiving the plurality of codewords, or a combination thereof.

An apparatus for receiving information indicating DMRS ports for codewords, in one embodiment, includes a receiver that receives downlink control information. In such an embodiment, the downlink control information includes first information used to indicate a plurality of demodulation reference signal ports for transmitting a plurality of codewords, receiving the plurality of codewords, or a combination thereof. In certain embodiments, the apparatus includes a processor that determines a set of demodulation reference signal ports of the plurality of demodulation reference signal ports for each codeword of the plurality of codewords based on a demodulation reference signal group configuration. In some embodiments, the receiver receives second information indicating a plurality of reference signals for transmitting the plurality of codewords, receiving the plurality of codewords, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for indicating DMRS ports for codewords;

FIG. 2 is a schematic block diagram illustrating one embodiment of an apparatus that may be used for receiving information indicating DMRS ports for codewords;

FIG. 3 is a schematic block diagram illustrating one embodiment of an apparatus that may be used for indicating DMRS ports for codewords;

FIG. 4 is a schematic block diagram illustrating one embodiment of a system for multi TRP communication;

FIG. 5 is a schematic flow chart diagram illustrating one embodiment of a method for indicating DMRS ports for codewords; and

FIG. 6 is a schematic flow chart diagram illustrating one embodiment of a method for receiving information indicating DMRS ports for codewords.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

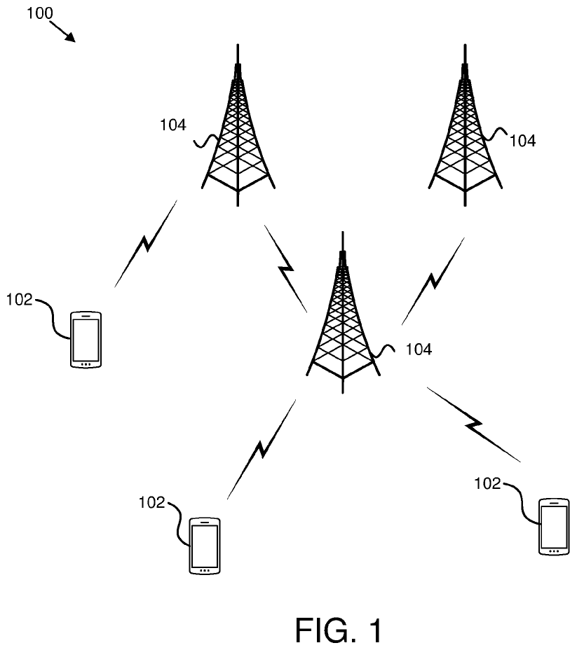

FIG. 1 depicts an embodiment of a wireless communication system 100 for indicating DMRS ports for codewords. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a RAN, a relay node, a device, a network device, an IAB node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the 3GPP protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit downlink control information. In such an embodiment, the downlink control information includes first information used to indicate a plurality of demodulation reference signal ports for transmitting a plurality of codewords, receiving the plurality of codewords, or a combination thereof. In certain embodiments, the network unit 104 may transmit second information indicating a plurality of reference signals for transmitting the plurality of codewords, receiving the plurality of codewords, or a combination thereof. Accordingly, a network unit 104 may be used for indicating DMRS ports for codewords.

In various embodiments, a remote unit 102 may receive downlink control information. In such embodiments, the downlink control information includes first information used to indicate a plurality of demodulation reference signal ports for transmitting a plurality of codewords, receiving the plurality of codewords, or a combination thereof. In certain embodiments, the remote unit 102 may determine a set of demodulation reference signal ports of the plurality of demodulation reference signal ports for each codeword of the plurality of codewords based on a demodulation reference signal group configuration. In some embodiments, the remote unit 102 may receive second information indicating a plurality of reference signals for transmitting the plurality of codewords, receiving the plurality of codewords, or a combination thereof. Accordingly, a remote unit 102 may be used for receiving information indicating DMRS ports for codewords.

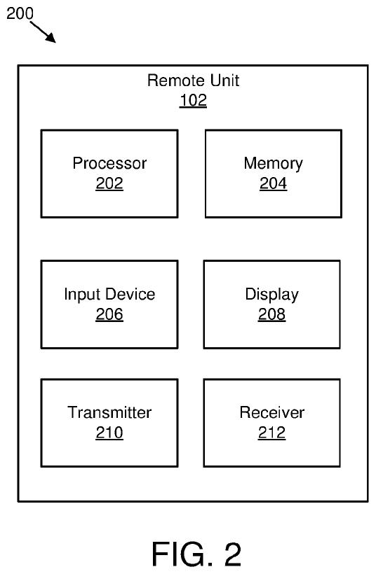

FIG. 2 depicts one embodiment of an apparatus 200 that may be used for receiving information indicating DMRS ports for codewords. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. In some embodiments, the processor 202 may determine a set of demodulation reference signal ports of a plurality of demodulation reference signal ports for each codeword of the plurality of codewords based on a demodulation reference signal group configuration. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The transmitter 210 is used to provide UL communication signals to the network unit 104 and the receiver 212 is used to receive DL communication signals from the network unit 104. In one embodiment, the receiver 212: receives downlink control information, wherein the downlink control information includes first information used to indicate a plurality of demodulation reference signal ports for transmitting a plurality of codewords, receiving the plurality of codewords, or a combination thereof; and receives second information indicating a plurality of reference signals for transmitting the plurality of codewords, receiving the plurality of codewords, or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

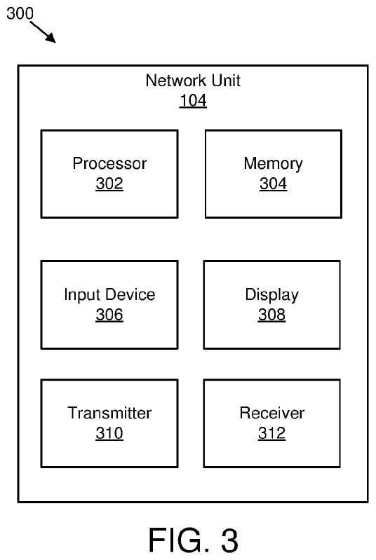

FIG. 3 depicts one embodiment of an apparatus 300 that may be used for indicating DMRS ports for codewords. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the transmitter 310: transmits downlink control information, wherein the downlink control information comprises first information used to indicate a plurality of demodulation reference signal ports for transmitting a plurality of codewords, receiving the plurality of codewords, or a combination thereof; and transmits second information indicating a plurality of reference signals for transmitting the plurality of codewords, receiving the plurality of codewords, or a combination thereof. Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In various embodiments, a UE (e.g., a remote unit 102) may not know which DMRS ports to use for multi-TRP (e.g., from multiple network units 104) and/or multi-panel transmissions (e.g., from one network unit 104) for receiving PDSCH and/or the UE may not know which DMRS ports to use for transmitting PUSCH for multiple TRPs and/or multiple panels.

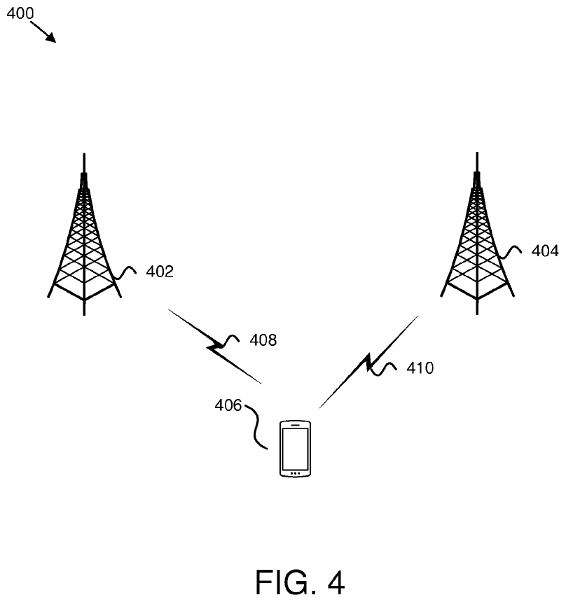

FIG. 4 is a schematic block diagram illustrating one embodiment of a system 400 for multi TRP communication. The system 400 includes a first TRP 402 and a second TRP 404 that make concurrent (e.g., simultaneous, overlapping) transmissions to a UE 406 (e.g., having one or more panels). In one embodiment, the system 400 may include multiple PDCCHs that schedule multiple PDSCHs and/or PUSCHs from the first TRP 402 and the second TRP 404. In such an embodiment, communications between the first TRP 402 and the UE 406 may include communications 408, such as PDCCH (e.g., PDCCH0), PDSCH (e.g., PDSCH0), and PUSCH (e.g., PUSCH0), and communications between the second TRP 404 and the UE 406 may include communications 410, such as PDCCH (e.g., PDCCH1), PDSCH (e.g., PDSCH1), and PUSCH (e.g., PUSCH1).

In another embodiment, the system 400 may include only a single PDCCH (e.g., transmitted from only one of the TRPs—transmitted either from the first TRP 402 or from the second TRP 404) that is used to schedule one PDSCH (e.g., for carrying a codeword for each TRP) and/or one PUSCH (e.g., for carrying a codeword for each TRP) corresponding to both of the first TRP 402 and the second TRP 404. In such an embodiment, communications between the first TRP 402 and the UE 406 may include communications 408, such as PDCCH (e.g., PDCCH0 that includes information that indicates DMRS ports for carrying CW0 and CW1), PDSCH (e.g., for carrying CW0 from the first TRP 402 to the UE 406), and PUSCH (e.g., for carrying CW0 from the UE 406 to the first TRP 402), and communications between the second TRP 404 and the UE 406 may include communications 410, such as PDSCH (e.g., for carrying CW1 from the second TRP 404 to the UE 406), and PUSCH (e.g., for carrying CW1 from the UE 406 to the second TRP 404).

In certain embodiments, such as to support multi-TRP and/or multi-panel communications in the system 400, two codewords with up to eight layers and enhanced layer mapping may be used. In some embodiments, precoding information (e.g., TPMI) of both codewords is indicated in an UL grant and a number of layers of each CW (e.g., represented by N_{cw1} and N_{cw2}) may be derived from the precoding information. In some embodiments, two or more RSs may be indicated by TCI states in DCI or SRI in an UL grant to be used for carrying the CWs. In such embodiments, each RS may correspond to QCL DMRS ports used for carrying one codeword in a higher frequency band (e.g., FR2, not FR1).

Embodiments that use a single PDCCH transmitted from the first TRP 402 to schedule one PUSCH with two codewords transmitted from one panel of the UE 406 (e.g., for ideal backhaul only) may be performed in a variety of ways as described herein. Moreover, embodiments that use a single PDCCH transmitted from the first TRP 402 to schedule PDSCH transmission from the first TRP 402 and the second TRP 404 may be performed to indicate DMRS ports for both TRPs as described herein.

Tables 1 through 62 are found herein. Each of the tables may correspond to a plurality of antenna ports and may be for a certain DMRS CDM group configuration with parameters such as DMRS type and maximum length of front-load DMRS. In some of the tables, a DMRS ports index (e.g., table header “DMRS port(s)”) indicated in an entry of such tables may be ordered by N_{cw1} ports corresponding to a first codeword (e.g., CW0) transmitted from a first panel followed by N_{cw2} ports corresponding to a second codeword (e.g., CW1) transmitted from a second panel. For example, referencing Table 5 row starting with “Value”=2, the column “DMRS port(s)”=0; 2, 3 and the column “N_{cw1}, N_{cw2}”=1, 2. This means that the number of layers for CW0=1 and the number of layers for CW1=2, and the DMRS ports corresponding to the number of layers are listed for CW0 followed by CW1 (e.g., separated by a “;”), thus DMRS port 0 corresponds to CW0 and DMRS ports 2 and 3 correspond to CW1. In some embodiments, the UE 406 may get spatial relation information for each DMRS port based on a number of layers of each codeword indicated in an UL grant without knowledge of a specific CDM group configuration for a panel. In such embodiments, the UE 406 may transmit CW0 with the first N_{cw1} DMRS ports of the indication with the same beam used by the first panel to transmit SRS resources and may transmit CW1 with the last N_{cw2} DMRS ports with the same beam used by the second panel to transmit SRS resources, where k_{cwi} is a number of layers of an i^{th} codeword indicated in the UL grant.

In certain embodiments, there may be two CDM groups for DMRS type 1 and three CDM groups for DMRS type 2. For DMRS type 1, each panel may be configured with one CDM group. In various embodiments, a difference between different CDM groups is an offset of one RB in a frequency domain. In some embodiments, DMRS ports in a first CDM group are used for first panel transmission and DMRS ports in a second CDM group are used for second panel transmission. For DMRS type 2, a panel may be configured with one or two CDM groups. In certain embodiments, DMRS ports in a first CDM group are used for first panel transmission, DMRS ports in a second CDM group are used for second panel transmission, and DMRS ports in the third CDM group may be used for first panel transmission, second panel transmission, and/or no panel transmission. The configuration for the DMRS ports in the third CDM group may be dynamically, persistently, and/or semi-persistently configured (e.g., preconfigured, predetermined, indicated, signaled, etc.).

In one example, there may be two codewords for a PUSCH, and each codeword may be transmitted from one panel. In this example, the DMRS configuration for the PUSCH transmission is type 1, and the maximum length of the front-load DMRS is two. Accordingly, there may be two CDM groups and each CDM group may have up to four ports. Moreover, DMRS port indexes in a first CDM group may be ports 0/1/4/5 and DMRS port indexes in a second CDM group may be ports 2/3/6/7. Furthermore, DMRS ports in the first CDM group are used for first panel transmission and DMRS ports in the second CDM group are used for second panel transmission. If a number of layers for the two codewords are three and one respectively, then a gNB (e.g., the first TRP 402) may transmit information to the UE 406 to indicate Value=4 in Table 6. Thus, based on Table 6, the UE 406 may transmit the first three DMRS ports (e.g., ports 0/1/4) with the same beam as the transmission of SRS resources from the first panel and may transmit the last DMRS port (e.g., port 7) with the same beam as the transmission of SRS resources from the second panel.

In another example, there may be two codewords for a PUSCH, and each codeword may be transmitted from one panel. In this example, the DMRS configuration for the PUSCH transmission is type 2, and the maximum length of the front-load DMRS is two. Accordingly, there may be three CDM groups and each CDM group may have up to four ports. Moreover, DMRS port indexes in a first CDM group may be ports 0/1/6/7, DMRS port indexes in a second CDM group may be ports 2/3/8/9, and DMRS port indexes in a third CDM group may be ports 4/5/10/11. In this example, a number of layers for the two codewords is three for the first codeword and one for the second codeword. If the third CDM group is configured for first panel transmission, then a gNB (e.g., the first TRP 402) may indicate information to the UE 406 to indicate one value among values {3, 9, 13, 21} in Table 18. In this example, the gNB may transmit information to the UE 406 to indicate Value 3 in Table 18 in an UL grant. Thus, based on Table 18, the UE 406 may transmit the first three DMRS ports (e.g., ports 0/1/4) with the same beam as the transmission of SRS resources from the first panel and may transmit the last DMRS port (e.g., port 2) with the same beam as the transmission of SRS resources from the second panel.

Table 1 through Table 22 as found herein are designed for DMRS ports indication for UL transmission. Remaining DMRS ports in a CDM group in each entry of each table that are not assigned may be indicated to a UE for single panel transmission use. A dmrs-Type corresponding to the tables may be one or two and may be configured by higher layers, a maxLength may be a maximum length of front-load DMRS symbols, and a rank is a total number of layers for both codewords. In some embodiments, the maxLength and the rank may be indicated to the UE 406 by a gNB (e.g., the first TRP 402).

Table 1 through Table 3 correspond to DMRS port indication for DMRS type 1 with a maximum length of front-load DMRS being one symbol. Moreover, Table 1 is for a total of two DMRS ports for both codewords with a single port for each codeword. Furthermore, for Table 1 there are four ports that may support up to two co-scheduled UEs with multi-panel transmission. In some embodiments, the DMRS ports of co-scheduled UEs must be orthogonal. For example, if the DMRS ports of a first UE are ports 0 and 2, then the DMRS ports of a second UE will be ports 1 and 3. Accordingly, if a first UE with multiple panels is indicated to use Value 0 in Table 1, then the remaining ports 1 or 3 may be indicated to a second UE with a single panel (e.g., a first panel or a second panel). The DMRS group configuration for Table 1 is: transform precoder is disabled; dmrs-Type=1; maxLength=1; and rank=2.

TABLE 1

| | Number of | | |
|---|---|---|---|
| | DMRS CDM | | |
| | group(s) | DMRS | N_{cw1}, |
| Value | without data | port(s) | N_{cw2} |
| 0 | 2 | 0; 2 | 1, 1 |
| 1 | 2 | 1; 3 | 1, 1 |
| 2-7 | Reserved | Reserved | Reserved |

Table 2 and Table 3 correspond to DMRS port indication for three and four DMRS ports split between two codewords. The configurations of Table 2 cannot support MU configurations because they each use at least three ports. Specifically, Value 0 and Value 1 in Table 2 are for (N_{cw1}, N_{cw2})=(1, 2) and (N_{cw1}, N_{cw2})=(2, 1), respectively. The remaining DMRS port in a CDM group may be scheduled for a UE for single panel transmission use. For example, if the UE 406 (e.g., that uses multi-panel transmission) is indicated Value 0 in Table 2, the remaining port 1 in a first CDM group may be indicated to another UE for single panel transmissions. Table 3 is for four DMRS ports corresponding to two codewords, with two ports assigned to each codeword. The DMRS group configuration for Table 2 is: transform precoder is disabled; dmrs-Type=1; maxLength=1; and rank=3. The DMRS group configuration for Table 3 is: transform precoder is disabled; dmrs-Type=1; maxLength=1; and rank=4.

TABLE 2

| | Number of | | |
|---|---|---|---|
| | DMRS CDM | | |
| | group(s) | DMRS | N_{cw1}, |
| Value | without data | port(s) | N_{cw2} |
| 0 | 2 | 0; 2, 3 | 1, 2 |
| 1 | 2 | 0, 1; 2 | 2, 1 |
| 2-7 | Reserved | Reserved | Reserved |

TABLE 3

| | Number of | | |
|---|---|---|---|
| | DMRS CDM | | |
| | group(s) | DMRS | N_{cw1}, |
| Value | without data | port(s) | N_{cw2} |
| 0 | 2 | 0, 1; 2, 3 | 2, 2 |
| 1-7 | Reserved | Reserved | Reserved |

Table 4 through Table 10 correspond to DMRS port indication for DMRS type 1 with a maximum length of front-load DMRS being two symbols. Specifically, Table 4 is for a total of two DMRS ports for both codewords with a single port for each codeword. Furthermore, the first two entries in Table 4 are for one symbol front-load DMRS which duplicate information found in Table 1. Moreover, the remaining entries are for two symbol front-load DMRS. As may be appreciated, two symbol front-load DMRS may contain up to eight ports that may support up to four co-scheduled UEs with multi-panel transmission. In some embodiments, the DMRS ports of co-scheduled UEs must be orthogonal such that different entries from Table 4 may be indicated to different UEs. The DMRS group configuration for Table 4 is: transform precoder is disabled; dmrs-Type=1; maxLength=2; and rank=2.

TABLE 4

| | Number of | | Number | |
|---|---|---|---|---|
| | DMRS CDM | | of front- | |
| | group(s) | DMRS | load | N_{cw1}, |
| Value | without data | port(s) | symbols | N_{cw2} |
| 0 | 2 | 0; 2 | 1 | 1, 1 |
| 1 | 2 | 1; 3 | 1 | 1, 1 |
| 2 | 2 | 0; 2 | 2 | 1, 1 |
| 3 | 2 | 1; 3 | 2 | 1, 1 |
| 4 | 2 | 4; 6 | 2 | 1, 1 |
| 5 | 2 | 5; 7 | 2 | 1, 1 |
| 6-15 | Reserved | Reserved | Reserved | Reserved |

Table 5 is for a total of three DMRS ports for both codewords. Furthermore, the first two entries in Table 5 are for one symbol front-load DMRS which duplicate information found in Table 2. Moreover, the remaining entries are for two symbol front-load DMRS that may support up to two co-scheduled UEs with multi-panel transmission. Specifically, Values 2 and 4 in Table 5 are for (N_{cw1}, N_{cw2})=(1, 2) and Value 3 and 5 are for (N_{cw1}, N_{cw2})=(2, 1). In one embodiment, if the number of DMRS ports of a UE for CW0 is one and for CW1 two, then a gNB may indicate one value from Values {2, 4} in Table 5 to the UE. If there are co-scheduled UEs, a gNB must indicate different entries to different UEs such that the DMRS ports do not overlap between the UEs. The DMRS group configuration for Table 5 is: transform precoder is disabled; dmrs-Type=1; maxLength=2; and rank=3.

TABLE 5

| | Number of | | Number | |
|---|---|---|---|---|
| | DMRS CDM | | of front- | |
| | group(s) | DMRS | load | N_{cw1}, |
| Value | without data | port(s) | symbols | N_{cw2} |
| 0 | 2 | 0; 2, 3 | 1 | 1, 2 |
| 1 | 2 | 0, 1; 2 | 1 | 2, 1 |
| 2 | 2 | 0; 2, 3 | 2 | 1, 2 |
| 3 | 2 | 0, 1; 2 | 2 | 2, 1 |
| 4 | 2 | 5; 6, 7 | 2 | 1, 2 |
| 5 | 2 | 4, 5; 7 | 2 | 2, 1 |
| 6-15 | Reserved | Reserved | Reserved | Reserved |

Table 6 is for a total of four DMRS ports for both codewords. Furthermore, the first entry in Table 6 is for one symbol front-load DMRS which duplicates information found in Table 3. Moreover, the remaining entries are for two symbol front-load DMRS. Specifically, Values 1 and 2 in Table 6 are for (N_{cw1}, N_{cw2})=(2, 2) which may support up to two co-scheduled UEs with multi-panel transmission and each scheduled UE has two DMRS ports for each codeword. Value 3 in Table 6 is for (N_{cw1}, N_{cw2})=(1, 3) and Value 4 is for (N_{cw1}, N_{cw2})=(3, 1). Values 3 and 4 may be used for DMRS port indication for two scheduled UEs in which (N_{cw1}, N_{cw2}) of a first UE is (1, 3) and (N_{cw1}, N_{cw2}) of a second UE is (3, 1). The DMRS group configuration for Table 6 is: transform precoder is disabled; dmrs-Type=1; maxLength=2; and rank=4.

TABLE 6

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 0, 1; 2, 3 | 1 | 2, 2 |
| 1 | 2 | 0, 1; 2, 3 | 2 | 2, 2 |
| 2 | 2 | 4, 5; 6, 7 | 2 | 2, 2 |
| 3 | 2 | 5; 2, 3, 6 | 2 | 1, 3 |
| 4 | 2 | 0, 1, 4; 7 | 2 | 3, 1 |
| 5-15 | Reserved | Reserved | Reserved | Reserved |

Table 7 through Table 10 correspond to DMRS port indication for five to eight DMRS ports for both codewords, respectively. For these tables, there are eight ports, but not all of these ports may be used. However, MU configurations may not be supported for configurations with more than four ports assigned to a UE, so MU configurations may not be supported with Tables 7 through 10. Moreover, Tables 7 through 10 don't contain one symbol front-load DMRS because one symbol front-load DMRS can only support up to four DMRS port transmission. Values 0 to 3 in Table 7 are for DMRS indication to a UE for (N_{cw1}, N_{cw2})=(1, 4), (N_{cw1}, N_{cw2})=(2, 3), (N_{cw1}, N_{cw2})=(3, 2), and (N_{cw1}, N_{cw2})=(4, 1), respectively. Values 0 to 2 in Table 8 are for DMRS indication to a UE for (N_{cw1}, N_{cw2})=(2, 4), (N_{cw1}, N_{cw2})=(3, 3), and (N_{cw1}, N_{cw2})=(4, 2), respectively. Values 0 and 1 in Table 9 are for (N_{cw1}, N_{cw2})=(3, 4) and (N_{cw1}, N_{cw2})=(4, 3), respectively. Table 10 is for a total of eight DMRS ports for both codewords with four ports for each codeword. The DMRS group configuration for Table 7 is: transform precoder is disabled; dmrs-Type=1; maxLength=2; and rank=5.

TABLE 7

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 5; 2, 3, 6, 7 | 2 | 1, 4 |
| 1 | 2 | 0, 1; 2, 3, 6 | 2 | 2, 3 |
| 2 | 2 | 0, 1, 4; 2, 3 | 2 | 3, 2 |
| 3 | 2 | 0, 1, 4, 5; 7 | 2 | 4, 1 |
| 4-15 | Reserved | Reserved | Reserved | Reserved |

The DMRS group configuration for Table 8 is: transform precoder is disabled; dmrs-Type=1; maxLength=2; and rank=6.

TABLE 8

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 0, 1; 2, 3, 6, 7 | 2 | 2, 4 |
| 1 | 2 | 0, 1, 4; 2, 3, 6 | 2 | 3, 3 |
| 2 | 2 | 0, 1, 4, 5; 2, 3 | 2 | 4, 2 |
| 3-15 | Reserved | Reserved | Reserved | Reserved |

The DMRS group configuration for Table 9 is: transform precoder is disabled; dmrs-Type=1; maxLength=2; and rank=7.

TABLE 9

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 0, 1, 4; 2, 3, 6, 7 | 2 | 3, 4 |
| 1 | 2 | 0, 1, 4, 5; 2, 3, 6 | 2 | 4, 3 |
| 2-15 | Reserved | Reserved | Reserved | Reserved |

The DMRS group configuration for Table 10 is: transform precoder is disabled; dmrs-Type=1; maxLength=2; and rank=8.

TABLE 10

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 0, 1, 4, 5; | 2 | 4, 4 |
| | | 2, 3, 6, 7 | | |
| 1-15 | Reserved | Reserved | Reserved | Reserved |

Table 11 through Table 15 correspond to DMRS port indication for DMRS type 2 with a maximum length of front-load DMRS being one symbol. Specifically, Table 11 is for a total of two DMRS ports for both codewords with a single port for each codeword. Moreover, there are a total of four ports for two CDM groups and six ports for three CDM groups. The configurations of Table 11 may support up to two co-scheduled UEs with multi-panel transmission. Furthermore, the first two entries in Table 11 are for two CDM groups which duplicate information found in Table 1. Values 2, 3, 4, and 5 in Table 11 are for configurations in which CDM group 2 is configured for a first panel. Moreover, Values {2, 3} and {4, 5} in Table 11 are two paired options for DMRS indication for two scheduled UEs with multi-panel transmission. In one example of such a paired option, if a first UE is indicated Value 2 in Table 11, a second UE must be indicated Value 3. The two paired options are different because different DMRS ports are used which may provide more flexibility to a gNB. Values 2, 3, 6, and 7 in Table 11 are for configurations in which CDM group 2 is configured for a second panel. Values {2, 3} and {6, 7} in Table 11 are two paired options for DMRS indication for two scheduled UEs with multi-panel transmission. As may be appreciated, DMRS ports not used may be indicated to a UE configured for single panel transmission. The DMRS group configuration for Table 11 is: transform precoder is disabled; dmrs-Type=2; maxLength=1; and rank=2.

TABLE 11

| | Number of DMRS CDM | DMRS | |
|---|---|---|---|
| Value | group(s) without data | port(s) | N_{cw1}, N_{cw2} |
| 0 | 2 | 0; 2 | 1, 1 |
| 1 | 2 | 1; 3 | 1, 1 |
| 2 | 3 | 0; 2 | 1, 1 |
| 3 | 3 | 1; 3 | 1, 1 |
| 4 | 3 | 4; 2 | 1, 1 |
| 5 | 3 | 5; 3 | 1, 1 |
| 6 | 3 | 0; 4 | 1, 1 |
| 7 | 3 | 1; 5 | 1, 1 |
| 8-15 | Reserved | Reserved | Reserved |

Table 12 is for a total of three DMRS ports for both codewords. Table 12 illustrates some DMRS ports outside of brackets which means a third CDM group is configured for a first panel, and some DMRS ports inside brackets which means the third CDM group is configured for a second panel. The configurations of Table 12 may support up to two co-scheduled UEs for multi-panel transmission. Moreover, the first two entries in Table 12 are for two CDM groups which duplicate information found in Table 2. Values 2, 3, 5, 6, 7, and 9 in Table 12 are for configurations in which the third CDM group is configured for a first panel. Furthermore, Values 2, 5, 6, and 7 are for (N_{cw1}, N_{cw2})=(2, 1) and Value {2, 7} and {5, 6} are two paired options for DMRS indication for two scheduled UEs with multi-panel transmission. Moreover, Values 3 and 9 are for (N_{cw1}, N_{cw2})=(1, 2) which may provide more flexibility to a gNB. Values 2, 3, 4, 5, 6, and 8 in Table 12 are for configurations in which the third CDM group is configured for a second panel. Values 2 and 8 are for (N_{cw1}, N_{cw2})=(2, 1) of a single UE and Values 3, 4, 5, and 6 are for (N_{cw1}, N_{cw2})=(1, 2). Values {3, 4} and {5, 6} are two paired options for DMRS indication for two scheduled UEs with multi-panel transmission. In one embodiment, if a first UE is indicated Value 5 in Table 12, a second UE must be indicated Value 6. The DMRS group configuration for Table 12 is: transform precoder is disabled; dmrs-Type=2; maxLength=1; and rank=3.

TABLE 12

| | Number of DMRS CDM | DMRS | |
|---|---|---|---|
| Value | group(s) without data | port(s) | N_{cw1}, N_{cw2} |
| 0 | 2 | 0; 2, 3 | 1, 2 |
| 1 | 2 | 0, 1; 2 | 2, 1 |
| 2 | 3 | 0, 1; 2 | 2, 1 |
| 3 | 3 | 0; 2, 3 | 1, 2 |
| 4 | 3 | 1; 4, 5 | 1, 2 |
| 5 | 3 | 0, 4; 2(0; 4, 2) | 2, 1(1, 2) |
| 6 | 3 | 1, 5; 3(1; 5, 3) | 2, 1(1, 2) |
| 7 | 3 | 4, 5; 3 | 2, 1 |
| 8 | 3 | 0, 1; 4 | 2, 1 |
| 9 | 3 | 5; 2, 3 | 1, 2 |
| 10-15 | Reserved | Reserved | Reserved |

Table 13 through Table 15 are for DMRS port indication of a total of four, five, and six DMRS ports for both codewords, respectively. Moreover, there are a total of four ports for two CDM groups and six ports for three CDM groups. The configurations of Tables 13 through 15 cannot support MU configurations because they each use at least four ports. The first entry in Table 13 is for two CDM groups which duplicates information found in Table 3. Values 1, 2, 3, and 5 in Table 13 are for configurations in which the third CDM group is configured for a first panel. Moreover, Values 1, 2, and 5 in Table 13 are for (N_{cw1}, N_{cw2})=(2, 2) which may provide more flexibility to a gNB, and Value 3 is for (N_{cw1}, N_{cw2})=(3, 1). Values 1 to 4 in Table 13 are for configurations in which the third CDM group is configured for a second panel. Moreover, Value 1 is for (N_{cw1}, N_{cw2})=(1, 3) and Values 2, 3, and 4 are for (N_{cw1}, N_{cw2})=(2, 2).

Values 0 and 1 in Table 14 are used for configurations in which the third CDM group is configured for either a first panel or a second panel. For example, if the third CDM group is configured for a first panel, Values 0 and 1 in Table 14 are used for (N_{cw1}, N_{cw2})=(3, 2) and (N_{cw1}, N_{cw2})=(4, 1), respectively. Moreover, if the third CDM group is configured for a second panel, Values 0 and 1 in Table 14 are used for (N_{cw1}, N_{cw2})=(1, 4) and (N_{cw1}, N_{cw2})=(2, 3), respectively. Value 0 in Table 15 for the third CDM group configured for a first panel is for (N_{cw1}, N_{cw2})=(4, 2) and Value 0 in Table 15 for the third CDM group configured for a second panel is for (N_{cw1}, N_{cw2})=(2, 4). The DMRS group configuration for Table 13 is: transform precoder is disabled; dmrs-Type=2; maxLength=1; and rank=4.

TABLE 13

| | Number of DMRS CDM | DMRS | |
|---|---|---|---|
| Value | group(s) without data | port(s) | N_{cw1}, N_{cw2} |
| 0 | 2 | 0, 1; 2, 3 | 2, 2 |
| 1 | 3 | 1, 4; 2, 3(1; 4, 2, 3) | 2, 2(1, 3) |
| 2 | 3 | 0, 1; 2, 3 | 2, 2 |
| 3 | 3 | 0, 1, 4; 2(0, 1; 4, 2) | 3, 1(2, 2) |
| 4 | 3 | 0, 1; 4, 5 | 2, 2 |
| 5 | 3 | 4, 5; 2, 3 | 2, 2 |
| 6-15 | Reserved | Reserved | Reserved |

The DMRS group configuration for Table 14 is: transform precoder is disabled; dmrs-Type=2; maxLength=1; and rank=5.

TABLE 14

| | Number of DMRS CDM | DMRS | |
|---|---|---|---|
| Value | group(s) without data | port(s) | N_{cw1}, N_{cw2} |
| 0 | 3 | 1, 4, 5; 2, 3(1; 4, 5, 2, 3) | 3, 2(1, 4) |
| 1 | 3 | 0, 1, 4, 5; 2(0, 1; 4, 5, 2) | 4, 1(2, 3) |
| 2-15 | Reserved | Reserved | Reserved |

The DMRS group configuration for Table 15 is: transform precoder is disabled; dmrs-Type=2; maxLength=1; and rank=6.

TABLE 15

| | Number of DMRS CDM | DMRS | |
|---|---|---|---|
| Value | group(s) without data | port(s) | N_{cw1}, N_{cw2} |
| 0 | 3 | 0, 1, 4, 5; 2, | 4, 2(2, 4) |
| | | 3(0, 1; 4, 5, 2, 3) | |
| 1-15 | Reserved | Reserved | Reserved |

Table 16 through Table 22 correspond to DMRS port indication for DMRS type 2 with a maximum length of front-load DMRS being two symbols. Specifically, Table 16 is for a total of two DMRS ports for both codewords with a single port for each codeword. Moreover, the first eight entries in Table 16 are for one symbol front-load DMRS which duplicate information found in Table 11. There are a total of eight ports for two CDM groups with two symbols front-load DMRS and twelve ports for three CDM groups with two symbols front-load DMRS. The configurations of Table 16 may support up to four co-scheduled UEs with multi-panel transmission. Furthermore, the first four entries of two symbol front-load DMRS are for two CDM groups that may support up to four co-scheduled UEs with multi-panel transmission. As may be appreciated, the DMRS ports of co-scheduled UEs must be orthogonal such that different entries are indicated to different UEs. Values 12, 13, 14, 15, 20, 21, 22, and 23 in Table 16 are for DMRS port indication for the third CDM group configured for a first panel. Moreover, Values {12, 13, 14, 15} and {20, 21, 22, 23} in Table 16 are two paired options for DMRS indication for four scheduled UEs. For example, if a UE is indicated Value 12 in Table 16, a co-scheduled UE with multi-panel transmission must be indicated one of Values {13, 14, 15}. The two paired options are different because different DMRS ports are used which may provide more flexibility to a gNB. Values 12 to 19 are for the third CDM group configured for a second panel. Moreover, Values {12, 13, 14, 15} and {16, 17, 18, 19} in Table 16 are two paired options for DMRS indication for four scheduled UEs with multi-panel transmission. The DMRS group configuration for Table 16 is: transform precoder is disabled; dmrs-Type=2; maxLength=2; and rank=2.

TABLE 16

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 0; 2 | 1 | 1, 1 |
| 1 | 2 | 1; 3 | 1 | 1, 1 |
| 2 | 3 | 0; 2 | 1 | 1, 1 |
| 3 | 3 | 1; 3 | 1 | 1, 1 |
| 4 | 3 | 4; 2 | 1 | 1, 1 |
| 5 | 3 | 5; 3 | 1 | 1, 1 |
| 6 | 3 | 0; 4 | 1 | 1, 1 |
| 7 | 3 | 1; 5 | 1 | 1, 1 |
| 8 | 2 | 0; 2 | 2 | 1, 1 |
| 9 | 2 | 1; 3 | 2 | 1, 1 |
| 10 | 2 | 6; 8 | 2 | 1, 1 |
| 11 | 2 | 7; 9 | 2 | 1, 1 |
| 12 | 3 | 0; 2 | 2 | 1, 1 |
| 13 | 3 | 1; 3 | 2 | 1, 1 |
| 14 | 3 | 6; 8 | 2 | 1, 1 |
| 15 | 3 | 7; 9 | 2 | 1, 1 |
| 16 | 3 | 0; 4 | 2 | 1, 1 |
| 17 | 3 | 1; 5 | 2 | 1, 1 |
| 18 | 3 | 6; 10 | 2 | 1, 1 |
| 19 | 3 | 7; 11 | 2 | 1, 1 |
| 20 | 3 | 4; 2 | 2 | 1, 1 |
| 21 | 3 | 5; 3 | 2 | 1, 1 |
| 22 | 3 | 10; 8 | 2 | 1, 1 |
| 23 | 3 | 11; 9 | 2 | 1, 1 |
| 24-31 | Reserved | Reserved | Reserved | Reserved |

Table 17 is for a total of three DMRS ports for both codewords. Moreover, the first ten entries in Table 17 are for one symbol front-load DMRS which duplicate information found in Table 12. The configuration of Table 17 may support up to four co-scheduled UEs with multi-panel transmission. Furthermore, the first four entries of two symbol front-load DMRS are for two CDM groups which may support up to two co-scheduled UEs with multi-panel transmission. Values 10 and 11 are for (N_{cw1}, N_{cw2})=(1, 2) and Value 12 and 13 are for (N_{cw1}, N_{cw2})=(2, 1). Moreover, Values 14 to 17 and Value 22 to 29 in Table 17 are for third CDM group configured for a first panel. Values {16, 17, 22, 24} and {26, 27, 28, 29} are for (N_{cw1}, N_{cw2})=(2, 1) which are two paired options for DMRS indication for up to four scheduled UEs with multi-panel transmission. Furthermore, Values {14, 15} and {23, 25} are for (N_{cw1}, N_{cw2})=(1, 2) which are two paired options for DMRS indication for up to two scheduled UEs with multi-panel transmission. Values 14 to 21 and Values 26 to 29 in Table 17 are for the third CDM group configured for a second panel. Moreover, Values {14, 15, 19, 21} and {26, 27, 28, 29} are for (N_{cw1}, N_{cw2})=(1, 2) which are two paired options for DMRS indication for up to four scheduled UEs with multi-panel transmission. Values {16, 17} and {18, 20} are for (N_{cw1}, N_{cw2})=(2, 1) which are two paired options for DMRS indication for up to two scheduled UEs with multi-panel transmission. The DMRS group configuration for Table 17 is: transform precoder is disabled; dmrs-Type=2; maxLength=2; and rank=3.

TABLE 17

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 0; 2, 3 | 1 | 1, 2 |
| 1 | 2 | 0, 1; 2 | 1 | 2, 1 |
| 2 | 3 | 0, 1; 2 | 1 | 2, 1 |
| 3 | 3 | 0; 2, 3 | 1 | 1, 2 |
| 4 | 3 | 1; 4, 5 | 1 | 1, 2 |
| 5 | 3 | 0, 4; 2(0; 4, 2) | 1 | 2, 1(1, 2) |
| 6 | 3 | 1, 5; 3(1; 5, 3) | 1 | 2, 1(1, 2) |
| 7 | 3 | 4, 5; 3 | 1 | 2, 1 |
| 8 | 3 | 0, 1; 4 | 1 | 2, 1 |
| 9 | 3 | 5; 2, 3 | 1 | 1, 2 |
| 10 | 2 | 0; 2, 3 | 2 | 1, 2 |
| 11 | 2 | 7; 8, 9 | 2 | 1, 2 |
| 12 | 2 | 0, 1; 2 | 2 | 2, 1 |
| 13 | 2 | 6, 7; 9 | 2 | 2, 1 |
| 14 | 3 | 0; 2, 3 | 2 | 1, 2 |
| 15 | 3 | 7; 8, 9 | 2 | 1, 2 |
| 16 | 3 | 0, 1; 2 | 2 | 2, 1 |
| 17 | 3 | 6, 7; 9 | 2 | 2, 1 |
| 18 | 3 | 0, 1; 4 | 2 | 2, 1 |
| 19 | 3 | 1; 4, 5 | 2 | 1, 2 |
| 20 | 3 | 6, 7; 11 | 2 | 2, 1 |
| 21 | 3 | 6; 10, 11 | 2 | 1, 2 |
| 22 | 3 | 4, 5; 3 | 2 | 2, 1 |
| 23 | 3 | 5; 2, 3 | 2 | 1, 2 |
| 24 | 3 | 10, 11; 8 | 2 | 2, 1 |
| 25 | 3 | 11; 8, 9 | 2 | 1, 2 |
| 26 | 3 | 0, 4; 2(0; 4, 2) | 2 | 2, 1(1, 2) |
| 27 | 3 | 1, 5; 3(1; 5, 3) | 2 | 2, 1(1, 2) |
| 28 | 3 | 6, 10; 8(6; 8, 10) | 2 | 2, 1(1, 2) |
| 29 | 3 | 7, 11; 9(7; 11, 9) | 2 | 2, 1(1, 2) |
| 30-31 | Reserved | Reserved | Reserved | Reserved |

Table 18 is for a total of four DMRS ports for both codewords. Moreover, the first six entries in Table 18 are for one symbol front-load DMRS which duplicate information found in Table 13. The configuration of Table 18 may support up to two co-scheduled UEs with multi-panel transmission. Furthermore, the first four entries of two symbol front-load DMRS are for two CDM groups which may support up to two co-scheduled UEs with multi-panel transmission. Values 7 and 8 in Table 18 are for (N_{cw1}, N_{cw2})=(2, 2) for up to two co-scheduled UEs and each scheduled UE has two DMRS ports for each codewords. Moreover, Value 6 in Table 18 is for (N_{cw1}, N_{cw2})=(1, 3) and Value 9 is for (N_{cw1}, N_{cw2})=(3, 1). Values 6 and 9 may also be used for DMRS ports indication for two scheduled UEs in which (N_{cw1}, N_{cw2}) of a first UE is (1, 3) and (N_{cw1}, N_{cw2}) of a second UE is (3, 1). Values 10 to 13 and 18 to 21 in Table 18 may be used for the third CDM group configured for a first panel. Moreover, Values {11, 12} and {18, 19} may be for (N_{cw1}, N_{cw2})=(2, 2) which are two paired options for DMRS indication for up to two scheduled UEs with multi-panel transmission. Values 10 and 20 may be for (N_{cw1}, N_{cw2})=(1, 3) and Values 13 and 21 may be for (N_{cw1}, N_{cw2})=(3, 1). Furthermore, Values {10, 13} and {20, 21} may support up to two scheduled UEs in which (N_{cw1}, N_{cw2}) of a first UE is (1, 3) and (N_{cw1}, N_{cw2}) of a second UE is (3, 1). Values 10 to 17 may be for the third CDM group configured for a second panel. Values {11, 12} and {16, 17} may be for (N_{cw1}, N_{cw2})=(2, 2) which are two paired options for DMRS indication for up to two scheduled UEs with multi-panel transmission. Moreover, Values 10 and 14 may be for (N_{cw1}, N_{cw2})=(1, 3) and Values 13 and 15 may be for (N_{cw1}, N_{cw2})=(3, 1). Values {10, 13} and {14, 15} may support up to two scheduled UEs in which (N_{cw1}, N_{cw2}) of a first UE is (1, 3) and (N_{cw1}, N_{cw2}) of a second UE is (3, 1). The DMRS group configuration for Table 18 is: transform precoder is disabled; dmrs-Type=2; maxLength=2; and rank=4.

TABLE 18

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 2 | 0, 1; 2, 3 | 1 | 2, 2 |
| 1 | 3 | 1, 4; 2, | 1 | 2, 2(1, 3) |
| | | 3(1; 4, 2, 3) | | |
| 2 | 3 | 0, 1; 2, 3 | 1 | 2, 2 |
| 3 | 3 | 0, 1, 4; | 1 | 3, 1(2, 2) |
| | | 2(0, 1; 4, 2) | | |
| 4 | 3 | 0, 1; 4, 5 | 1 | 2, 2 |
| 5 | 3 | 4, 5; 2, 3 | 1 | 2, 2 |
| 6 | 2 | 7; 2, 3, 8 | 2 | 1, 3 |
| 7 | 2 | 0, 1; 2, 3 | 2 | 2, 2 |
| 8 | 2 | 6, 7; 8, 9 | 2 | 2, 2 |
| 9 | 2 | 0, 1, 6; 9 | 2 | 3, 1 |
| 10 | 3 | 7; 2, 3, 8 | 2 | 1, 3 |
| 11 | 3 | 0, 1; 2, 3 | 2 | 2, 2 |
| 12 | 3 | 6, 7; 8, 9 | 2 | 2, 2 |
| 13 | 3 | 0, 1, 6; 9 | 2 | 3, 1 |
| 14 | 3 | 7; 4, 5, 10 | 2 | 1, 3 |
| 15 | 3 | 0, 1, 6; 11 | 2 | 3, 1 |
| 16 | 3 | 0, 1; 4, 5 | 2 | 2, 2 |
| 17 | 3 | 6, 7; 10, 11 | 2 | 2, 2 |
| 18 | 3 | 4, 5; 2, 3 | 2 | 2, 2 |
| 19 | 3 | 10, 11; 8, 9 | 2 | 2, 2 |
| 20 | 3 | 11; 2, 3, 8 | 2 | 1, 3 |
| 21 | 3 | 4, 5, 10; 9 | 2 | 3, 1 |
| 22-31 | Reserved | Reserved | Reserved | Reserved |

Table 19 is for a total of five DMRS ports for both codewords. Moreover, the first two entries in Table 19 are for one symbol front-load DMRS which duplicate information found in Table 14. The first four entries of two symbol front-load DMRS are for two CDM groups that can't support MU configurations, but three CDM groups may support up to two co-scheduled UEs with multi-panel transmission. Furthermore, the Values 2, 3, 4, and 5 in Table 19 are for (N_{cw1}, N_{cw2})=(1, 4), (N_{cw1}, N_{cw2})=(2, 3), (N_{cw1}, N_{cw2}), =(3, 2) and (N_{cw1}, N_{cw2})=(4, 1), respectively.

Values 6, 8, 10, 11, 12, 13, 15, and 17 in Table 19 are for the third CDM group configured for a first panel. Moreover, Values {10, 11} and {12, 13} are two options for DMRS indication for up to two scheduled UEs. The configuration of Table 19 may support up to two co-scheduled UEs with multi-panel transmission. Furthermore, the configuration of Table 19 may support up to two co-scheduled UEs with multi-panel transmission for (N_{cw1}, N_{cw2})=(3, 2) and (N_{cw1}, N_{cw2})=(4, 1). Values 6 and 15 are for (N_{cw1}, N_{cw2})=(1, 4) and Values 8 and 17 are for (N_{cw1}, N_{cw2})=(2, 3) for a single UE. Moreover, Values 6, 7, 8, 9, 10, 12, 14, and 16 in Table 19 are for the third CDM group configured for a second panel. Values {6, 7} and {8, 9} are two options for DMRS indication for up to two scheduled UEs for (N_{cw1}, N_{cw2})=(1, 4) and (N_{cw1}, N_{cw2})=(2, 3), respectively. Furthermore, Values 10 and 16 are for (N_{cw1}, N_{cw2})=(3, 2) and Values 12 and 14 are for (N_{cw1}, N_{cw2})=(4, 1) for a single UE. The DMRS group configuration for Table 19 is: transform precoder is disabled; dmrs-Type=2; maxLength=2; and rank=5.

TABLE 19

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 3 | 1, 4, 5; 2, | 1 | 3, 2(1, 4) |
| | | 3(1; 4, 5, 2, 3) | | |
| 1 | 3 | 0, 1, 4, 5; | 1 | 4, 1(2, 3) |
| | | 2(0, 1; 4, 5, 2), | | |
| 2 | 2 | 7; 2, 3, 8, 9 | 2 | 1, 4 |
| 3 | 2 | 0, 1; 2, 3, 8 | 2 | 2, 3 |
| 4 | 2 | 0, 1, 6; 2, 3 | 2 | 3, 2 |
| 5 | 2 | 0, 1, 6, 7; 9 | 2 | 4, 1 |
| 6 | 3 | 7; 2, 3, 8, 9 | 2 | 1, 4 |
| 7 | 3 | 0; 4, 5, 10, 11 | 2 | 1, 4 |
| 8 | 3 | 0, 1; 2, 3, 8 | 2 | 2, 3 |
| 9 | 3 | 6, 7; 4, 5, 10 | 2 | 2, 3 |
| 10 | 3 | 0, 1, 6; 2, 3 | 2 | 3, 2 |
| 11 | 3 | 4, 5, 10; 8, 9 | 2 | 3, 2 |
| 12 | 3 | 0, 1, 6, 7; 2 | 2 | 4, 1 |
| 13 | 3 | 4, 5, 10, 11; 9 | 2 | 4, 1 |
| 14 | 3 | 0, 1, 6, 7; 11 | 2 | 4, 1 |
| 15 | 3 | 11; 2, 3, 8, 9 | 2 | 1, 4 |
| 16 | 3 | 0, 1, 6; 4, 5 | 2 | 3, 2 |
| 17 | 3 | 10, 11; 2, 3, 8 | 2 | 2, 3 |
| 18-31 | Reserved | Reserved | Reserved | Reserved |

Table 20 is for a total of six DMRS ports for both codewords. Moreover, the first entry in Table 20 is for one symbol front-load DMRS which duplicates information found in Table 15. The first three entries of two symbol front-load DMRS are for two CDM groups that can't support MU configurations, but three CDM groups may support up to two co-scheduled UEs with multi-panel transmission. Furthermore, the Values 1, 2, and 3 in Table 20 are for (N_{cw1}, N_{cw2})=(2, 4), (N_{cw1}, N_{cw2})=(3, 3), and (N_{cw1}, N_{cw2})=(4, 2), respectively.

Values 4, 6, 7, 8, 10, and 12 in Table 20 are for the third CDM group configured for a first panel. Moreover, Values 7 and 8 are two options for DMRS indication for up to two scheduled UEs. The configuration of Table 20 may support up to two co-scheduled UEs with multi-panel transmission for (N_{cw1}, N_{cw2})=(4, 2). Furthermore, Values 4 and 12 are for (N_{cw1}, N_{cw2})=(2, 4) and values 6 and 10 are for (N_{cw1}, N_{cw2})=(3, 3) for a single UE which enable a gNB more flexibility. Values 4, 5, 6, 7, 9, and 11 in Table 20 are for the third CDM group configured for a second panel. Moreover, Values 4 and 5 are two options for DMRS indication for up to two scheduled UEs for (N_{cw1}, N_{cw2})=(2, 4). Values 7 and 11 are for (N_{cw1}, N_{cw2})=(4, 2) and Values 6 and 9 are for (N_{cw1}, N_{cw2})=(3, 3) for a single UE. The DMRS group configuration for Table 20 is: transform precoder is disabled; dmrs-Type=2; maxLength=2; and rank=6.

TABLE 20

| | Number of DMRS | | Number of | |
|---|---|---|---|---|
| | CDM group(s) | DMRS | front-load | |
| Value | without data | port(s) | symbols | N_{cw1}, N_{cw2} |
| 0 | 3 | 0, 1, 4, 5; 2, | 1 | 4, 2(2, 4) |
| | | 3(0, 1; 4, 5, 2, 3) | | |
| 1 | 2 | 0, 1; 2, 3, 8, 9 | 2 | 2, 4 |
| 2 | 2 | 0, 1, 6; 2, 3, 8 | 2 | 3, 3 |
| 3 | 2 | 0, 1, 6, 7; 2, 3 | 2 | 4, 2 |
| 4 | 3 | 0, 1; 2, 3, 8, 9 | 2 | 2, 4 |
| 5 | 3 | 6, 7; 4, 5, 10, 11 | 2 | 2, 4 |
| 6 | 3 | 0, 1, 6; 2, 3, 8 | 2 | 3, 3 |
| 7 | 3 | 0, 1, 6, 7; 2, 3 | 2 | 4, 2 |
| 8 | 3 | 4, 5, 10, 11; 8, 9 | 2 | 4, 2 |
| 9 | 3 | 0, 1, 6; 4, 5, 10 | 2 | 3, 3 |
| 10 | 3 | 4, 5, 10; 2, 3, 8 | 2 | 3, 3 |
| 11 | 3 | 0, 1, 6, 7; 4, 5 | 2 | 4, 2 |
| 12 | 3 | 10, 11; 2, 3, 8, 9 | 2 | 2, 4 |
| 13-31 | Reserved | Reserved | Reserved | Reserved |

Table 21 and Table 22 are for DMRS port indication for a total of seven and eight DMRS ports for both codewords, respectively. There are a total of eight ports for two CDM groups and twelve ports for three CDM groups with two symbol front-load DMRS. Tables 21 and 22 cannot support MU scenario for more than six ports of a UE. Moreover, Tables 21 and 22 do not contain one symbol of front-load DMRS because one symbol front-load DMRS may only support up to six DMRS ports transmission. The first two entries in Table 21 of two symbol front-load DMRS are for two CDM groups. Furthermore, the Values 0 and 1 in Table 21 are for (N_{cw1}, N_{cw2})=(3, 4) and (N_{cw1}, N_{cw2})=(4, 3), respectively.

Values 2, 3, 6, and 7 in Table 21 are for the third CDM group configured for a first panel. Moreover, Values 2 and 7 are for (N_{cw1}, N_{cw2})=(3, 4) and Values 3 and 6 are for (N_{cw1}, N_{cw2})=(4, 3) for a single UE. Values 2 to 5 in Table 21 are for the third CDM group configured for a second panel. Furthermore, Values 2 and 4 are for (N_{cw1}, N_{cw2})=(3, 4) and Values 3 and 5 are for (N_{cw1}, N_{cw2})=(4, 3) for a single UE.

The first entry in Table 22 is for two CDM groups. Moreover, Value 0 in Table 22 is for (N_{cw1}, N_{cw2})=(4, 4). Values 1 and 3 in Table 22 are for the third CDM group configured for a first panel for (N_{cw1}, N_{cw2})=(4, 4). Furthermore, Values 1 and 2 in Table 22 are for the third CDM group configured for a second panel for (N_{cw1}, N_{cw2})=(4, 4) for a single UE. The DMRS group configuration for Table 21 is: transform precoder is disabled; dmrs-Type=2; maxLength=2; and rank=7.

TABLE 21

| | Number of DMRS | | Number | |
|---|---|---|---|---|
| | CDM group(s) | | of front- | N_{cw1}, |
| Value | without data | DMRS port(s) | load symbols | N_{cw2} |
| 0 | 2 | 0, 1, 6; 2, 3, 8, 9 | 2 | 3, 4 |
| 1 | 2 | 0, 1, 6, 7; 2, 3, 8 | 2 | 4, 3 |
| 2 | 3 | 0, 1, 6; 2, 3, 8, 9 | 2 | 3, 4 |
| 3 | 3 | 0, 1, 6, 7; 2, 3, 8 | 2 | 4, 3 |
| 4 | 3 | 0, 1, 6; 4, 5, 10, 11 | 2 | 3, 4 |
| 5 | 3 | 0, 1, 6, 7; 4, 5, 10 | 2 | 4, 3 |
| 6 | 3 | 4, 5, 10, 11; 2, 3, 8 | 2 | 4, 3 |
| 7 | 3 | 4, 5, 10; 2, 3, 8, 9 | 2 | 3, 4 |
| 8-31 | Reserved | Reserved | Reserved | Reserved |

The DMRS group configuration for Table 22 is: transform precoder is disabled; dmrs-Type=2; maxLength=2; and rank=8.

TABLE 22

| | Number of DMRS CDM | | Number of front-load | |
|---|---|---|---|---|
| Value | group(s) without data | DMRS port(s) | symbols | N_{cw1}, N_{cw2} |
| 0 | 2 | 0, 1, 6, 7; 2, 3, 8, 9 | 2 | 4, 4 |
| 1 | 3 | 0, 1, 6, 7; 2, 3, 8, 9 | 2 | 4, 4 |
| 2 | 3 | 0, 1, 6, 7; 4, 5, 10, 11 | 2 | 4, 4 |
| 3 | 3 | 4, 5, 10, 11; 2, 3, 8, 9 | 2 | 4, 4 |
| 4-31 | Reserved | Reserved | Reserved | Reserved |

In some embodiments, a DMRS group may be used to support multi-TRP and/or multi-panel PDSCH and/or PUSCH transmission. In such embodiments, DMRS ports within a DMRS group may be QCL, and DMRS ports from different groups may not be QCL. In certain embodiments, one DMRS group is QCL with one or more RSs indicated by TCI states in DCI or SRI in an UL grant. In such embodiments, the DMRS ports transmitted from a TRP and/or panel may be selected from within one DMRS group. In various embodiments, a DMRS group may include one or two CDM groups. In such embodiments, a CDM group can only be configured to one DMRS group (e.g., a CDM group cannot be configured to more than one DMRS group). In some embodiments, two DMRS groups are used for two codewords transmitted from two TRPs and/or panels. In certain embodiments, DMRS ports in a first DMRS group for PDSCH may be received with the same beam as the reception of one or more RSs from the first TRP 402 and DMRS ports in a second DMRS group for PDSCH may be received with the same beam as the reception of one or more RSs from the second TRP 404. In various embodiments, DMRS ports in a first DMRS group for PUSCH may be transmitted with the same beam as the transmission of one or more SRS resources from a first panel and DMRS ports in a second DMRS group for PUSCH may be transmitted with the same beam as the transmission of one or more SRS resources from a second panel.

In certain embodiments, for DMRS type 1 with two CDM groups, each DMRS group may include one CDM group. In such embodiments, a first DMRS group contains a first CDM group used for the first TRP 402 or the first panel, and a second DMRS group contains a second CDM group used for the second TRP 404 or the second panel. In various embodiments, a difference between different CDM groups is an offset of one RB in a frequency domain. In some embodiments, a DMRS group ID may be used as a panel ID, or a panel ID may be used as a DMRS group ID. In such embodiments, the DMRS group ID may be used as the panel ID explicitly or implicitly, or the panel ID may be used as the DMRS group ID explicitly or implicitly.

In certain embodiments, for DMRS type 2 with three CDM groups and one symbol front-load DMRS, if a link quality between one TRP and one panel is good at a certain time, a corresponding DMRS group may be configured with two CDM groups to support up to four ports. However, if the link become bad, the DMRS group may be configured with only one CDM group. In various embodiments, for DMRS type 2, a DMRS group configuration may be indicated in DCI. In one embodiment, a first DMRS group may contain (e.g., always contains) a first CDM group used for the first TRP 402 or the first panel, and a second DMRS group may contain (e.g., always contains) a second CDM group used for the second TRP 404 or the second panel. In some embodiments, one bit in DCI may be used to indicate whether a third CDM group is in a first DMRS group or in a second DMRS group. In certain embodiments, two bits in DCI may be used to indicate whether a third CDM group is in a first DMRS group, in a second DMRS group, or not in any DMRS group (e.g., in no DMRS group).

As may be appreciated, by dividing DMRS ports into DMRS groups, a UE does not need to know a number of layers that correspond to each codeword. For example, if a UE knows the contents of a DMRS group, it can easily know which DMRS ports are QCL that may be transmitted with the same beam and which ports cannot be transmitted with the same beam.

For embodiments that use DMRS groups, Tables 1 through 22 may be used for UL transmission; however, the DMRS ports do not need to be in any particular order. Tables 23 through 26 may be used for DL transmission. As long as the UE has the information needed to select the correct table, has a Value for the table, and has the DMRS group information, the UE may know which DMRS ports to use for which codewords. As may be appreciated, any of the tables found herein are examples of possible tables. However, it should be noted that, in some embodiments, the actual tables used may be similar to the tables found herein, but may have different ordering, DMRS ports, etc.

In one example, there are two codewords of a PUSCH and each codeword is transmitted from one panel. Moreover, the DMRS configuration for the PUSCH transmission is type 2 and the maximum length of front-load DMRS is one. Accordingly, there are a total of three CDM groups and each CDM group has up to two ports. In such an example, DMRS ports index in a first CDM group are ports 0/1, DMRS ports in a second CDM group are ports 2/3, and DMRS ports in a third CDM group are ports 4/5. Moreover, an UL grant comprises an indication indicating that the third CDM group belongs to the first DMRS group (e.g., a bit is 0 indicating that the third CDM group belongs to the first DMRS group); therefore, the first DMRS group contains the first CDM group and the third CDM group, and the second DMRS group contains the second CDM group. In this example, if the number of layers of the two codewords are two and two, respectively, then the gNB may indicate to the UE 406 one of Values {0, 1, 2, 5} in Table 13. For example, Value 1 may be indicated in the UL grant, then the UE 406 may transmit using the DMRS ports in the first DMRS group (e.g., ports 1/4) with the same beam as the transmission of SRS resources from a first panel and transmit using the DMRS ports in the second DMRS group (e.g., ports 2/3) with the same beam as the transmission of SRS resources from a second panel.

In another example, there are two codewords of a PDSCH and each codeword is transmitted from one TRP. Moreover, the DMRS configuration for the PDSCH transmission is type 2 and the maximum length of front-load DMRS is two. Accordingly, there are a total of three CDM groups and each CDM group with up to four ports. In such an example, DMRS ports index in a first CDM group are ports 0/1/6/7, DMRS ports in a second CDM group are ports 2/3/8/9, and DMRS ports in a third CDM group are ports 4/5/10/11. Moreover, DCI comprises an indication indicating that the third CDM group belongs to the second DMRS group (e.g., a bit is 1 indicating that the third CDM group belongs to the second DMRS group); therefore, the first DMRS group contains the first CDM group transmitted from the first TRP 402, and the second DMRS group contains the second CDM group and the third CDM group transmitted from the second TRP 404. In this example, if the number of layers of the two codewords are two and four, respectively, then the gNB may indicate to the UE 406 one of Values {16, 45, 46} in Table 26. For example, Value 46 may be indicated in DCI, then the UE 406 may receive information using the DMRS ports in the first DMRS group (e.g., port 6/7) with the same beam as the reception of RSs from the first TRP 402 and receive DMRS ports in the second DMRS group (e.g., ports 4/5/10/11) with the same beam as the reception of RSs from the second TRP 404.

The DMRS group configuration for Table 23 is: transform precoder is disabled; dmrs-Type=1; and maxLength=1.

TABLE 23

| Value | Number of DMRS CDM group(s) without data | DMRS port(s) |
|---|---|---|
| 0 | 2 | 0, 2 |
| 1 | 2 | 1, 3 |
| 2 | 2 | 0, 2, 3 |
| 3 | 2 | 0, 1, 2 |
| 4 | 2 | 0, 1, 2, 3 |
| 5-8 | Reserved | Reserved |

The DMRS group configuration for Table 24 is: transform precoder is disabled; dmrs-Type=1; and maxLength=2.

TABLE 24

| | Number of DMRS CDM | | Number of |
|---|---|---|---|
| Value | group(s) without data | DMRS port(s) | front-load symbols |
| 0 | 2 | 0, 2 | 1 |
| 1 | 2 | 1, 3 | 1 |
| 2 | 2 | 0, 2, 3 | 1 |
| 3 | 2 | 0, 1, 2 | 1 |
| 4 | 2 | 0, 1, 2, 3 | 1 |
| 5 | 2 | 0, 2 | 2 |
| 6 | 2 | 1, 3 | 2 |
| 7 | 2 | 4, 6 | 2 |
| 8 | 2 | 5, 7 | 2 |
| 9 | 2 | 0, 2, 3 | 2 |
| 10 | 2 | 0, 1, 2 | 2 |
| 11 | 2 | 5, 6, 7 | 2 |
| 12 | 2 | 4, 5, 7 | 2 |
| 13 | 2 | 0, 1, 2, 3 | 2 |
| 14 | 2 | 4, 5, 6, 7 | 2 |
| 15 | 2 | 5, 2, 3, 6 | 2 |
| 16 | 2 | 0, 1, 4, 7 | 2 |
| 17 | 2 | 5, 2, 3, 6, 7 | 2 |
| 18 | 2 | 0, 1, 2, 3, 6 | 2 |
| 19 | 2 | 0, 1, 4, 2, 3 | 2 |
| 20 | 2 | 0, 1, 4, 5, 7 | 2 |
| 21 | 2 | 0, 1, 2, 3, 6, 7 | 2 |
| 22 | 2 | 0, 1, 4, 2, 3, 6 | 2 |
| 23 | 2 | 0, 1, 4, 5, 2, 3 | 2 |
| 24 | 2 | 0, 1, 4, 2, 3, 6, 7 | 2 |
| 25 | 2 | 0, 1, 4, 5, 2, 3, 6 | 2 |
| 26 | 2 | 0, 1, 4, 5, 2, 3, 6, 7 | 2 |
| 27-31 | Reserved | Reserved | Reserved |

The DMRS group configuration for Table 25 is: transform precoder is disabled; dmrs-Type=2; and maxLength=1.

TABLE 25

| | Number of DMRS | |
|---|---|---|
| Value | CDM group(s) without data | DMRS port(s) |
| 0 | 2 | 0, 2 |
| 1 | 2 | 1, 3 |
| 2 | 2 | 0, 2, 3 |
| 3 | 2 | 0, 1, 2 |
| 4 | 2 | 0, 1, 2, 3 |
| 5 | 3 | 0, 2 |
| 6 | 3 | 1, 3 |
| 7 | 3 | 4, 2 |
| 8 | 3 | 5, 3 |
| 9 | 3 | 0, 4 |
| 10 | 3 | 1, 5 |
| 11 | 3 | 0, 1, 2 |
| 12 | 3 | 0, 2, 3 |
| 13 | 3 | 1, 4, 5 |
| 14 | 3 | 0, 4, 2 |
| 15 | 3 | 1, 5, 3 |
| 16 | 3 | 4, 5, 3 |
| 17 | 3 | 0, 1, 4 |
| 18 | 3 | 5, 2, 3 |
| 19 | 3 | 1, 4, 2, 3 |
| 20 | 3 | 0, 1, 2, 3 |
| 21 | 3 | 0, 1, 4, 2 |
| 22 | 3 | 0, 1, 4, 5 |
| 23 | 3 | 4, 5, 2, 3 |
| 24 | 3 | 1, 4, 5, 2, 3 |
| 25 | 3 | 0, 1, 4, 5, 2 |
| 26 | 3 | 0, 1, 4, 5, 2, 3 |
| 27-31 | Reserved | Reserved |

The DMRS group configuration for Table 26 is: transform precoder is disabled; dmrs-Type=2; and maxLength=2.

TABLE 26

| | Number of DMRS CDM | | Number of |
|---|---|---|---|
| Value | group(s) without data | DMRS port(s) | front-load symbols |
| 0 | 2 | 0, 2 | 1 |
| 1 | 2 | 1, 3 | 1 |
| 2 | 2 | 0, 2, 3 | 1 |
| 3 | 2 | 0, 1, 2 | 1 |
| 4 | 2 | 0, 1, 2, 3 | 1 |
| 5 | 3 | 0, 2 | 1 |
| 6 | 3 | 1, 3 | 1 |
| 7 | 3 | 0, 1, 2 | 1 |
| 8 | 3 | 0, 2, 3 | 1 |
| 9 | 3 | 1, 4, 5 | 1 |
| 10 | 3 | 4, 5, 3 | 1 |
| 11 | 3 | 1, 4, 2, 3 | 1 |
| 12 | 3 | 0, 1, 2, 3 | 1 |
| 13 | 3 | 0, 1, 4, 2 | 1 |
| 14 | 3 | 1, 4, 5, 2, 3 | 1 |
| 15 | 3 | 0, 1, 4, 5, 2 | 1 |
| 16 | 3 | 0, 1, 4, 5, 2, 3 | 1 |
| 17 | 3 | 0, 2 | 2 |
| 18 | 3 | 1, 3 | 2 |
| 19 | 3 | 6, 8 | 2 |
| 20 | 3 | 7, 9 | 2 |
| 21 | 3 | 0, 2, 3 | 2 |
| 22 | 3 | 7, 8, 9 | 2 |
| 23 | 3 | 0, 1, 2 | 2 |
| 24 | 3 | 6, 7, 9 | 2 |
| 25 | 3 | 1, 4, 5 | 2 |
| 26 | 3 | 6, 10, 11 | 2 |
| 27 | 3 | 4, 5, 3 | 2 |
| 28 | 3 | 10, 11, 8 | 2 |
| 29 | 3 | 0, 2, 3, 8 | 2 |
| 30 | 3 | 0, 1, 2, 3 | 2 |
| 31 | 3 | 6, 7, 8, 9 | 2 |
| 32 | 3 | 0, 1, 6, 2 | 2 |
| 33 | 3 | 7, 4, 5, 10 | 2 |
| 34 | 3 | 4, 5, 10, 9 | 2 |
| 35 | 3 | 1, 6, 7, 9 | 2 |
| 36 | 3 | 7, 3, 8, 9 | 2 |
| 37 | 3 | 7, 2, 3, 8, 9 | 2 |
| 38 | 3 | 0, 4, 5, 10, 11 | 2 |
| 39 | 3 | 0, 1, 2, 3, 8 | 2 |
| 40 | 3 | 6, 7, 4, 5, 10 | 2 |
| 41 | 3 | 0, 1, 6, 2, 3 | 2 |
| 42 | 3 | 4, 5, 10, 8, 9 | 2 |
| 43 | 3 | 0, 1, 6, 7, 2 | 2 |
| 44 | 3 | 4, 5, 10, 11, 9 | 2 |
| 45 | 3 | 0, 1, 6, 4, 5 | 2 |
| 46 | 3 | 10, 11, 2, 3, 8 | 2 |
| 47 | 3 | 0, 1, 2, 3, 8, 9 | 2 |
| 48 | 3 | 6, 7, 4, 5, 10, 11 | 2 |
| 49 | 3 | 0, 1, 6, 2, 3, 8 | 2 |
| 50 | 3 | 0, 1, 6, 7, 2, 3 | 2 |
| 51 | 3 | 4, 5, 10, 11, 8, 9 | 2 |
| 52 | 3 | 0, 1, 6, 7, 4, 5 | 2 |
| 53 | 3 | 10, 11, 2, 3, 8, 9 | 2 |
| 54 | 3 | 0, 1, 6, 2, 3, 8, 9 | 2 |
| 55 | 3 | 0, 1, 6, 7, 2, 3, 8 | 2 |
| 56 | 3 | 0, 1, 6, 7; 2, 3, 8, 9 | 2 |
| 57-63 | Reserved | Reserved | Reserved |

In some embodiments, for multiple PDCCH based multi-TRP and/or multi-panel transmission, each of the first TRP 402 and the second TRP 404 may schedule its own PDSCH and PUSCH independently. As may be appreciated, because a message between the first TRP 402 and the second TRP 404 cannot be exchanged dynamically, RRC may configure a CDM group index and a total number of CDM groups for a TRP and/or panel to avoid a CDM group configured to more than one panel. In certain embodiments, there may be fully overlapped PUSCH resource allocation; therefore, orthogonal DMRS ports may be allocated for each TRP and/or panel. For example, a first CDM group may be assigned to a first panel and a second CDM group may be assigned to a second panel.

In various embodiments, a gNB may indicate DMRS ports in a CDM group or a DMRS group configured for its own TRP and/or panel. Tables 27 through 30 may be used by the gNB to indicate the DMRS ports. Tables 27 through 30 may be similar to tables used in other configurations with the addition of more entries. In contrast, Tables 31 through 66 may be new tables not used in other configurations. The Tables 31 through 66 may be simplified from Tables 27 through 30 to reduce a number of bits used in DCI to indicate an entry in such tables.

Table 27 and Table 28 are for PUSCH transmission with multi-panels. Table 29 and Table 30 are for PDSCH with multi-TRPs transmission.

The DMRS group configuration for Table 27 is: transform precoder is disabled; dmrs-Type=2; maxLength=1; and rank=3.

TABLE 27

| | Number of DMRS | |
|---|---|---|
| Value | CDM group(s) without data | DMRS port(s) |
| 0 | 2 | 0-2 |
| 1 | 3 | 0-2 |
| 2 | 3 | 3-5 |
| 3 | 3 | 0, 1, 4 |
| 4-15 | Reserved | Reserved |

The DMRS group configuration for Table 28 is: transform precoder is disabled; dmrs-Type=2; maxLength=1; and rank=4.

TABLE 28

| Value | Number of DMRS CDM group(s) without data | DMRS port(s) |
|---|---|---|
| 0 | 2 | 0-3 |
| 1 | 3 | 0-3 |
| 2 | 3 | 0, 1, 4, 5 |
| 3 | 3 | 2, 3, 4, 5 |
| 4-15 | Reserved | Reserved |

The DMRS group configuration for Table 29 is: dmrs-Type=2; and maxLength=1.

TABLE 29

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number | | | Number | |
| | of DMRS | | | of DMRS | |
| | CDM | | | CDM | |
| | group(s) | | | group(s) | |
| | without | DMRS | | without | DMRS |
| Value | data | port(s) | Value | data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 3 | 0, 1, 4 | | | |
| 25 | 3 | 0, 1, 4, 5 | | | |
| 26 | 3 | 2, 3, 4, 5 | | | |
| 27-31 | Reserved | Reserved | | | |

The DMRS group configuration for Table 30 is: dmrs-Type=2; and maxLength=2.

TABLE 30

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number | | DMRS CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 3 | 0, 1, 4 | 1 | | | | |
| 59 | 3 | 0, 1, 4, 5 | 1 | | | | |
| 60 | 3 | 2, 3, 4, 5 | 1 | | | | |
| 61-63 | Reserved | Reserved | Reserved | | | | |

In some embodiments, Tables 31 through 58 may be used for DMRS port indication for PUSCH, and Tables 59 through 66 may be used for DMRS port indication for PDSCH. In such embodiments, for DMRS type 1 with maxLength equals one, two bits may be saved compared to other tables, and other configurations may save one bit in DCI compared with other tables. Tables 31 through 66 may be used as pairs of tables in which a first table is used for a first TRP and/or panel and a second table is used for a second TRP and/or panel. For example, Table 31 and Table 32 are for the same configuration for a pair of TRPs and/or panels. If DMRS ports for a first TRP and/or panel are indicated in Table 31, the DMRS ports for a second TRP and/or panel are indicated in Table 32. Tables 33 and 34 are for another configuration for a pair of TRPs and/or panels as are each two consecutive tables that follow Table 34. The DMRS group configuration for Table 31 is: transform precoder is disabled; dmrs-Type=1; maxLength=1; and rank=1.

TABLE 31

| | Number of DMRS | |
|---|---|---|
| Value | CDM group(s) without data | DMRS port(s) |
| 0 | 2 | 0 |
| 1 | 2 | 1 |

The DMRS group configuration for Table 32 is: transform precoder is disabled; dmrs-Type=1; maxLength=1; and rank=1.

TABLE 32

| | Number of DMRS | |
|---|---|---|
| Value | CDM group(s) without data | DMRS port(s) |
| 0 | 2 | 2 |
| 1 | 2 | 3 |

The DMRS group configuration for Table 33 is: transform precoder is disabled; dmrs-Type=1; maxLength=1; and rank=2.

TABLE 33

| | Number of DMRS | |
|---|---|---|
| Value | CDM group(s) without data | DMRS port(s) |
| 0 | 2 | 0, 1 |
| 1 | Reserved | Reserved |

The DMRS group configuration for Table 34 is: transform precoder is disabled; dmrs-Type=1; maxLength=1; and rank=2.

TABLE 34

| | Number of DMRS | |
|---|---|---|
| Value | CDM group(s) without data | DMRS port(s) |
| 0 | 2 | 2, 3 |
| 1 | Reserved | Reserved |

The DMRS group configuration for Table 35 is: transform precoder is disabled; dmrs-Type=1; maxLength=2; and rank=1.

TABLE 35

| | Number of DMRS CDM | DMRS | Number of front-load |
|---|---|---|---|
| Value | group(s) without data | port(s) | symbols |
| 0 | 2 | 0 | 1 |
| 1 | 2 | 1 | 1 |
| 2 | 2 | 0 | 2 |
| 3 | 2 | 1 | 2 |
| 4 | 2 | 4 | 2 |
| 5 | 2 | 5 | 2 |
| 6-7 | Reserved | Reserved | Reserved |

The DMRS group configuration for Table 36 is: transform precoder is disabled; dmrs-Type=1; maxLength=2; and rank=1.

TABLE 36

| | Number of DMRS CDM | DMRS | Number of front-load |
|---|---|---|---|
| Value | group(s) without data | port(s) | symbols |
| 0 | 2 | 2 | 1 |
| 1 | 2 | 3 | 1 |
| 2 | 2 | 2 | 2 |
| 3 | 2 | 3 | 2 |
| 4 | 2 | 6 | 2 |
| 5 | 2 | 7 | 2 |
| 6-7 | Reserved | Reserved | Reserved |

The DMRS group configuration for Table 37 is: transform precoder is disabled; dmrs-Type=1; maxLength=2; and rank=2.

TABLE 37

| | Number of DMRS | | Number of |
|---|---|---|---|
| | CDM group(s) | DMRS | front-load |
| Value | without data | port(s) | symbols |
| 0 | 2 | 0, 1 | 1 |
| 1 | 2 | 0, 1 | 2 |
| 2 | 2 | 4, 5 | 2 |
| 3 | 2 | 0, 4 | 2 |
| 4-7 | Reserved | Reserved | Reserved |

The DMRS group configuration for Table 38 is: transform precoder is disabled; dmrs-Type=1; maxLength=2; and rank=2.

TABLE 38

| | Number of DMRS | | Number of |
|---|---|---|---|
| | CDM group(s) | DMRS | front-load |
| Value | without data | port(s) | symbols |
| 0 | 2 | 2, 3 | 1 |
| 1 | 2 | 2, 3 | 2 |
| 2 | 2 | 6, 7 | 2 |
| 3 | 2 | 2, 6 | 2 |
| 4-7 | Reserved | Reserved | Reserved |

The DMRS group configuration for Table 39 is: transform precoder is disabled; dmrs-Type=1; maxLength=2; and rank=3.

TABLE 39

| | Number of DMRS | | Number of |
|---|---|---|---|
| | CDM group(s) | DMRS | front-load |
| Value | without data | port(s) | symbols |
| 0 | 2 | 0, 1, 4 | 2 |
| 1-7 | Reserved | Reserved | Reserved |

The DMRS group configuration for Table 40 is: transform precoder is disabled; dmrs-Type=1; maxLength=2; and rank=3.

TABLE 40

| | Number of DMRS | | Number of |
|---|---|---|---|
| | CDM group(s) | DMRS | front-load |
| Value | without data | port(s) | symbols |
| 0 | 2 | 2, 3, 6 | 2 |
| 1-7 | Reserved | Reserved | Reserved |

The DMRS group configuration for Table 41 is: transform precoder is disabled; dmrs-Type=1; maxLength=2; and rank=4.

TABLE 41

| | Number of DMRS | | Number of |
|---|---|---|---|
| | CDM group(s) | DMRS | front-load |
| Value | without data | port(s) | symbols |
| 0 | 2 | 0, 1, 4, 5 | 1 |
| 1-7 | Reserved | Reserved | Reserved |

The DMRS group configuration for Table 42 is: transform precoder is disabled; dmrs-Type=1; maxLength=2; and rank=4.

TABLE 42

| | Number of DMRS | | Number of |
|---|---|---|---|
| | CDM group(s) | DMRS | front-load |
| Value | without data | port(s) | symbols |
| 0 | 2 | 2, 3, 6, 7 | 1 |
| 1-7 | Reserved | Reserved | Reserved |

The DMRS group configuration for Table 43 is: transform precoder is disabled; dmrs-Type=2; maxLength=1; and rank=1.

TABLE 43

| | Number of DMRS CDM group(s) | |
|---|---|---|
| Value | without data | DMRS port(s) |
| 0 | 2 | 0 |
| 1 | 2 | 1 |
| 2 | 3 | 0 |
| 3 | 3 | 1 |
| 4 | 3 | 4 |
| 5 | 3 | 5 |
| 6-7 | Reserved | Reserved |

The DMRS group configuration for Table 44 is: transform precoder is disabled; dmrs-Type=2; maxLength=1; and rank=1.

TABLE 44

| | Number of DMRS CDM group(s) | |
|---|---|---|
| Value | without data | DMRS port(s) |
| 0 | 2 | 2 |
| 1 | 2 | 3 |
| 2 | 3 | 2 |
| 3 | 3 | 3 |
| 4 | 3 | 4 |
| 5 | 3 | 5 |
| 6-7 | Reserved | Reserved |

The DMRS group configuration for Table 45 is: transform precoder is disabled; dmrs-Type=2; maxLength=1; and rank=2.

TABLE 45

| | Number of DMRS CDM group(s) | |
|---|---|---|
| Value | without data | DMRS port(s) |
| 0 | 2 | 0, 1 |
| 1 | 3 | 4, 5 |
| 2 | 3 | 0, 4 |
| 3-7 | Reserved | Reserved |

The DMRS group configuration for Table 46 is: transform precoder is disabled; dmrs-Type=2; maxLength=1; and rank=2.

TABLE 46

| | Number of DMRS CDM group(s) | |
|---|---|---|
| Value | without data | DMRS port(s) |
| 0 | 2 | 2, 3 |
| 1 | 3 | 4, 5 |
| 2 | 3 | 2, 4 |
| 3-7 | Reserved | Reserved |

The DMRS group configuration for Table 47 is: transform precoder is disabled; dmrs-Type=2; maxLength=1; and rank=3.

TABLE 47

| | Number of DMRS CDM group(s) | |
|---|---|---|
| Value | without data | DMRS port(s) |
| 0 | 3 | 0, 1, 4 |
| 1-7 | Reserved | Reserved |

The DMRS group configuration for Table 48 is: transform precoder is disabled; dmrs-Type=2; maxLength=1; and rank=3.

TABLE 48

| | Number of DMRS CDM group(s) | |
|---|---|---|
| Value | without data | DMRS port(s) |
| 0 | 3 | 2, 3, 4 |
| 1-7 | Reserved | Reserved |

The DMRS group configuration for Table 49 is: transform precoder is disabled; dmrs-Type=2; maxLength=1; and rank=4.

TABLE 49

| | Number of DMRS CDM group(s) | |
|---|---|---|
| Value | without data | DMRS port(s) |
| 0 | 3 | 0, 1, 4, 5 |
| 1-7 | Reserved | Reserved |

The DMRS group configuration for Table 50 is: transform precoder is disabled; dmrs-Type=2; maxLength=1; and rank=4.

TABLE 50

| | Number of DMRS CDM group(s) | |
|---|---|---|
| Value | without data | DMRS port(s) |
| 0 | 3 | 2, 3, 4, 5 |
| 1-7 | Reserved | Reserved |

The DMRS group configuration for Table 51 is: transform precoder is disabled; dmrs-Type=2; maxLength=2; and rank=1.

TABLE 51

| | Number of DMRS | | Number of |
|---|---|---|---|
| | CDM group(s) | DMRS | front-load |
| Value | without data | port(s) | symbols |
| 0 | 2 | 0 | 1 |
| 1 | 2 | 1 | 1 |
| 2 | 3 | 0 | 1 |
| 3 | 3 | 1 | 1 |
| 4 | 3 | 4 | 1 |
| 5 | 3 | 5 | 1 |
| 6 | 3 | 0 | 2 |
| 7 | 3 | 1 | 2 |
| 8 | 3 | 4 | 2 |
| 9 | 3 | 5 | 2 |
| 10 | 3 | 6 | 2 |
| 11 | 3 | 7 | 2 |
| 12 | 3 | 10 | 2 |
| 13 | 3 | 11 | 2 |
| 14-15 | Reserved | Reserved | Reserved |

The DMRS group configuration for Table 52 is: transform precoder is disabled; dmrs-Type=2; maxLength=2; and rank=1.

TABLE 52

| | Number of DMRS CDM | DMRS | Number of front-load |
|---|---|---|---|
| Value | group(s) without data | port(s) | symbols |
| 0 | 2 | 2, | 1 |
| 1 | 2 | 3 | 1 |
| 2 | 3 | 2 | 1 |
| 3 | 3 | 3 | 1 |
| 4 | 3 | 4 | 1 |
| 5 | 3 | 5 | 1 |
| 6 | 3 | 2 | 2 |
| 7 | 3 | 3 | 2 |
| 8 | 3 | 4 | 2 |
| 9 | 3 | 5 | 2 |
| 10 | 3 | 8 | 2 |
| 11 | 3 | 9 | 2 |
| 12 | 3 | 10 | 2 |
| 13 | 3 | 11 | 2 |
| 14-15 | Reserved | Reserved | Reserved |

The DMRS group configuration for Table 53 is: transform precoder is disabled; dmrs-Type=2; maxLength=2; and rank=2.

TABLE 53

| | Number of DMRS CDM | DMRS | Number of front-load |
|---|---|---|---|
| Value | group(s) without data | port(s) | symbols |
| 0 | 2 | 0, 1 | 1 |
| 1 | 3 | 0, 1 | 1 |
| 2 | 3 | 4, 5 | 1 |
| 3 | 3 | 0, 4 | 1 |
| 4 | 2 | 0, 1 | 2 |
| 5 | 2 | 6, 7 | 2 |
| 6 | 3 | 0, 1 | 2 |
| 7 | 3 | 4, 5 | 2 |
| 8 | 3 | 6, 7 | 2 |
| 9 | 3 | 10, 11 | 2 |
| 10 | 3 | 0, 4 | 2 |
| 11-15 | Reserved | Reserved | Reserved |

The DMRS group configuration for Table 54 is: transform precoder is disabled; dmrs-Type=2; maxLength=2; and rank=2.

TABLE 54

| | Number of DMRS CDM | DMRS | Number of front-load |
|---|---|---|---|
| Value | group(s) without data | port(s) | symbols |
| 0 | 2 | 2, 3 | 1 |
| 1 | 3 | 2, 3 | 1 |
| 2 | 3 | 4, 5 | 1 |
| 3 | 3 | 2, 4 | 1 |
| 4 | 2 | 2, 3 | 2 |
| 5 | 2 | 8, 9 | 2 |
| 6 | 3 | 2, 3 | 2 |
| 7 | 3 | 4, 5 | 2 |
| 8 | 3 | 8, 9 | 2 |
| 9 | 3 | 10, 11 | 2 |
| 10 | 3 | 2, 4 | 2 |
| 11-15 | Reserved | Reserved | Reserved |

The DMRS group configuration for Table 55 is: transform precoder is disabled; dmrs-Type=2; maxLength=2; and rank=3.

TABLE 55

| | Number of DMRS CDM | DMRS | Number of front-load |
|---|---|---|---|
| Value | group(s) without data | port(s) | symbols |
| 0 | 3 | 0, 1, 4 | 1 |
| 1 | 2 | 0, 1, 6 | 2 |
| 2 | 3 | 0, 1, 4 | 2 |
| 3 | 3 | 4, 5, 10 | 2 |
| 4 | 3 | 0, 1, 6 | 2 |
| 5-15 | Reserved | Reserved | Reserved |

The DMRS group configuration for Table 56 is: transform precoder is disabled; dmrs-Type=2; maxLength=2; and rank=3.

TABLE 56

| | Number of DMRS CDM | DMRS | Number of front-load |
|---|---|---|---|
| Value | group(s) without data | port(s) | symbols |
| 0 | 3 | 2, 3, 4 | 1 |
| 1 | 2 | 2, 3, 8 | 2 |
| 2 | 3 | 2, 3, 4 | 2 |
| 3 | 3 | 4, 5, 10 | 2 |
| 4 | 3 | 2, 3, 8 | 2 |
| 5-15 | Reserved | Reserved | Reserved |

The DMRS group configuration for Table 57 is: transform precoder is disabled; dmrs-Type=2; maxLength=2; and rank=4.

TABLE 57

| | Number of DMRS CDM | DMRS | Number of front-load |
|---|---|---|---|
| Value | group(s) without data | port(s) | symbols |
| 0 | 3 | 0, 1, 4, 5 | 1 |
| 1 | 2 | 0, 1, 6, 7 | 2 |
| 2 | 3 | 4, 5, 10, 11 | 2 |
| 3 | 3 | 0, 1, 4, 5 | 2 |
| 4 | 3 | 0, 1, 6, 7 | 2 |
| 5-15 | Reserved | Reserved | Reserved |

The DMRS group configuration for Table 58 is: transform precoder is disabled; dmrs-Type=2; maxLength=2; and rank=4.

TABLE 58

| | Number of DMRS CDM | DMRS | Number of front-load |
|---|---|---|---|
| Value | group(s) without data | port(s) | symbols |
| 0 | 3 | 2, 3, 4, 5 | 1 |
| 1 | 2 | 2, 3, 8, 9 | 2 |
| 2 | 3 | 4, 5, 10, 11 | 2 |
| 3 | 3 | 2, 3, 4, 5 | 2 |
| 4 | 3 | 2, 3, 8, 9 | 2 |
| 5-15 | Reserved | Reserved | Reserved |

The DMRS group configuration for Table 59 is: dmrs-Type=1; and maxLength=1.

TABLE 59

| | Number of DMRS CDM | DMRS |
|---|---|---|
| Value | group(s) without data | port(s) |
| 0 | 2 | 0 |
| 1 | 2 | 1 |
| 2 | 2 | 0, 1 |
| 3 | Reserved | Reserved |

The DMRS group configuration for Table 60 is: dmrs-Type=1; and maxLength=1.

TABLE 60

| | Number of DMRS CDM | DMRS |
|---|---|---|
| Value | group(s) without data | port(s) |
| 0 | 2 | 2 |
| 1 | 2 | 3 |
| 2 | 2 | 2, 3 |
| 3 | Reserved | Reserved |

The DMRS group configuration for Table 61 is: dmrs-Type=1; and maxLength=2.

TABLE 61

| | Number of DMRS CDM | DMRS | Number of front- |
|---|---|---|---|
| Value | group(s) without data | port(s) | load symbols |
| 0 | 2 | 0 | 1 |
| 1 | 2 | 1 | 1 |
| 2 | 2 | 0, 1 | 1 |
| 3 | 2 | 0 | 2 |
| 4 | 2 | 1 | 2 |
| 5 | 2 | 4 | 2 |
| 6 | 2 | 5 | 2 |
| 7 | 2 | 0, 1 | 2 |
| 8 | 2 | 4, 5 | 2 |
| 9 | 2 | 0, 4 | 2 |
| 10 | 2 | 0, 1, 4 | 2 |
| 11 | 2 | 0, 1, 4, 5 | 2 |
| 12-15 | Reserved | Reserved | Reserved |

The DMRS group configuration for Table 62 is: dmrs-Type=1; and maxLength=2.

TABLE 62

| | Number of DMRS CDM | DMRS | Number of front-load |
|---|---|---|---|
| Value | group(s) without data | port(s) | symbols |
| 0 | 2 | 2 | 1 |
| 1 | 2 | 3 | 1 |
| 2 | 2 | 2, 3 | 1 |
| 3 | 2 | 2 | 2 |
| 4 | 2 | 3 | 2 |
| 5 | 2 | 6 | 2 |
| 6 | 2 | 7 | 2 |
| 7 | 2 | 2, 3 | 2 |
| 8 | 2 | 6, 7 | 2 |
| 9 | 2 | 2, 6 | 2 |
| 10 | 2 | 2, 3, 6 | 2 |
| 11 | 2 | 2, 3, 6, 7 | 2 |
| 12-15 | Reserved | Reserved | Reserved |

The DMRS group configuration for Table 63 is: dmrs-Type=2; and maxLength=1.

TABLE 63

| | Number of DMRS CDM | DMRS |
|---|---|---|
| Value | group(s) without data | port(s) |
| 0 | 2 | 0 |
| 1 | 2 | 1 |
| 2 | 2 | 0, 1 |
| 3 | 3 | 4 |
| 4 | 3 | 5 |
| 5 | 3 | 0 |
| 6 | 3 | 1 |
| 7 | 3 | 0, 1 |
| 8 | 3 | 0, 4 |
| 9 | 3 | 4, 5 |
| 10 | 3 | 0, 1, 4 |
| 11 | 3 | 0, 1, 4, 5 |
| 12-15 | Reserved | Reserved |

The DMRS group configuration for Table 64 is: dmrs-Type=2; and maxLength=1.

TABLE 64

| | Number of DMRS CDM | DMRS |
|---|---|---|
| Value | group(s) without data | port(s) |
| 0 | 2 | 2 |
| 1 | 2 | 3 |
| 2 | 2 | 2, 3 |
| 3 | 3 | 4 |
| 4 | 3 | 5 |
| 5 | 3 | 2 |
| 6 | 3 | 3 |
| 7 | 3 | 2, 3 |
| 8 | 3 | 2, 4 |
| 9 | 3 | 4, 5 |
| 10 | 3 | 2, 3, 4 |
| 11 | 3 | 2, 3, 4, 5 |
| 12-15 | Reserved | Reserved |

The DMRS group configuration for Table 65 is: dmrs-Type=2; and maxLength=2.

TABLE 65

| | Number of DMRS CDM | DMRS | Number of front-load |
|---|---|---|---|
| Value | group(s) without data | port(s) | symbols |
| 0 | 2 | 0 | 1 |
| 1 | 2 | 1 | 1 |
| 2 | 2 | 0, 1 | 1 |
| 3 | 3 | 0 | 1 |
| 4 | 3 | 1 | 1 |
| 5 | 3 | 4 | 1 |
| 6 | 3 | 5 | 1 |
| 7 | 3 | 0, 1 | 1 |
| 8 | 3 | 4, 5 | 1 |
| 9 | 3 | 0, 4 | 1 |
| 10 | 3 | 0, 1, 4 | 1 |
| 11 | 3 | 0, 1, 4, 5 | 1 |
| 12 | 3 | 0 | 2 |
| 13 | 3 | 1 | 2 |
| 14 | 3 | 4 | 2 |
| 15 | 3 | 5 | 2 |
| 16 | 3 | 6 | 2 |
| 17 | 3 | 7 | 2 |
| 18 | 3 | 10 | 2 |
| 19 | 3 | 11 | 2 |
| 20 | 3 | 0, 1 | 2 |
| 21 | 3 | 4, 5 | 2 |
| 22 | 3 | 6, 7 | 2 |
| 23 | 3 | 10, 11 | 2 |
| 24 | 3 | 4, 5, 10 | 2 |
| 25 | 3 | 0, 1, 6 | 2 |
| 26 | 3 | 0, 1, 6, 7 | 2 |
| 27 | 3 | 4, 5, 10, 11 | 2 |
| 28 | 2 | 0, 1 | 2 |
| 29 | 2 | 6, 7 | 2 |
| 30-31 | Reserved | Reserved | Reserved |

The DMRS group configuration for Table 66 is: dmrs-Type=2; and maxLength=2.

TABLE 66

| | Number of DMRS CDM | DMRS | Number of front-load |
|---|---|---|---|
| Value | group(s) without data | port(s) | symbols |
| 0 | 2 | 2 | 1 |
| 1 | 2 | 3 | 1 |
| 2 | 2 | 2, 3 | 1 |
| 3 | 3 | 4 | 1 |
| 4 | 3 | 5 | 1 |
| 5 | 3 | 2 | 1 |
| 6 | 3 | 3 | 1 |
| 7 | 3 | 2, 3 | 1 |
| 8 | 3 | 2, 4 | 1 |
| 9 | 3 | 4, 5 | 1 |
| 10 | 3 | 2, 3, 4 | 1 |
| 11 | 3 | 2, 3, 4, 5 | 1 |
| 12 | 3 | 2 | 2 |
| 13 | 3 | 3 | 2 |
| 14 | 3 | 4 | 2 |
| 15 | 3 | 5 | 2 |
| 16 | 3 | 8 | 2 |
| 17 | 3 | 9 | 2 |
| 18 | 3 | 10 | 2 |
| 19 | 3 | 11 | 2 |
| 20 | 3 | 2, 3 | 2 |
| 21 | 3 | 4, 5 | 2 |
| 22 | 3 | 8, 9 | 2 |
| 23 | 3 | 10, 11 | 2 |
| 24 | 3 | 4, 5, 10 | 2 |
| 25 | 3 | 2, 3, 8 | 2 |
| 26 | 3 | 2, 3, 8, 9 | 2 |
| 27 | 3 | 4, 5, 10, 11 | 2 |
| 28 | 2 | 2, 3 | 2 |
| 29 | 2 | 8, 9 | 2 |
| 30-31 | Reserved | Reserved | Reserved |

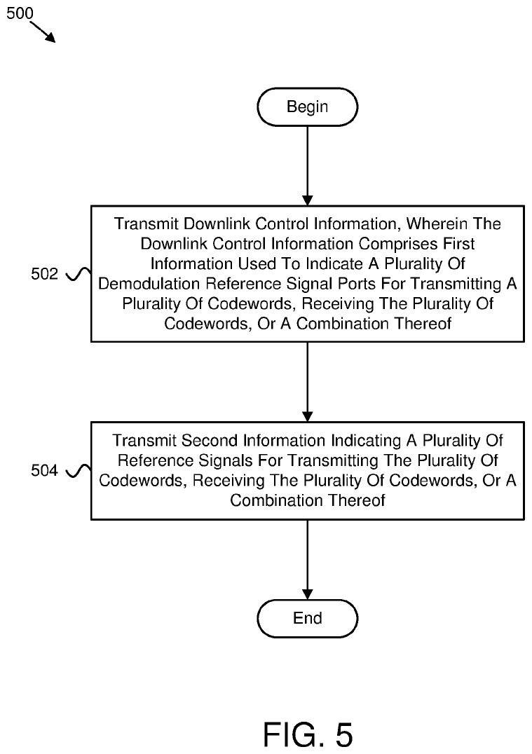

FIG. 5 is a schematic flow chart diagram illustrating one embodiment of a method 500 for indicating DMRS ports for codewords. In some embodiments, the method 500 is performed by an apparatus, such as the network unit 104. In certain embodiments, the method 500 may be performed by a processor executing program code, for example, a microcontroller, a microprocessor, a CPU, a GPU, an auxiliary processing unit, a FPGA, or the like.

The method 500 may include transmitting 502 downlink control information. In such an embodiment, the downlink control information includes first information used to indicate a plurality of demodulation reference signal ports for transmitting a plurality of codewords, receiving the plurality of codewords, or a combination thereof. In certain embodiments, the method 500 includes transmitting 504 second information indicating a plurality of reference signals for transmitting the plurality of codewords, receiving the plurality of codewords, or a combination thereof.

In certain embodiments, the first information indicates an entry in a table corresponding to a plurality of antenna ports. In some embodiments, the table is selected from a plurality of tables based on a demodulation reference signal configuration, a transmission rank, or a combination thereof. In various embodiments, the entry in the table is selected based on a demodulation reference signal group configuration, a transmission rank of each codeword, or a combination thereof.

In one embodiment, a demodulation reference signal group of a plurality of demodulation reference signal groups indicated by the demodulation reference signal group configuration comprises at least one code division multiplexed group of a plurality of code division multiplexed groups. In certain embodiments, each code division multiplexed group of the plurality of code division multiplexed groups corresponds to one demodulation reference signal group of a plurality of demodulation reference signal groups.

In some embodiments, the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

In various embodiments, a first code division multiplexed group of the plurality of code division multiplexed groups is assigned to the first demodulation reference signal group, and a second code division multiplexed group of the plurality of code division multiplexed groups is assigned to the second demodulation reference signal group. In one embodiment, a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

In certain embodiments, a demodulation reference signal group indicated by the demodulation reference signal group configuration corresponds to one transmission reception point of a plurality of transmission reception points, one panel of a plurality of panels, or a combination thereof. In some embodiments, the one panel comprises a panel identifier. In various embodiments, the panel identifier is used as a demodulation reference signal group identifier.

In one embodiment, a demodulation reference signal group identifier is associated with a panel identifier by higher layer parameters. In certain embodiments, the second information is indicated by a plurality of sounding reference signal resource indicators or transmission configuration indicator states. In some embodiments, each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

In various embodiments, each transmission configuration indicator state of the plurality of transmission configuration indicator states comprises a least one reference signal of the plurality of reference signals, and the at least one reference signal is quasi co-located with one demodulation reference signal group for downlink reception.

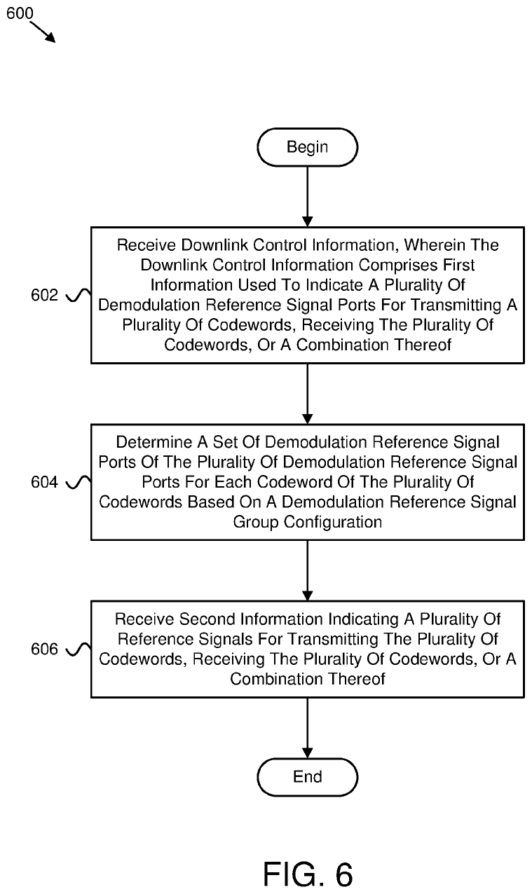

FIG. 6 is a schematic flow chart diagram illustrating another embodiment of a method 600 for receiving information indicating DMRS ports for codewords. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

The method 600 may include receiving 602 downlink control information. In such an embodiment, the downlink control information includes first information used to indicate a plurality of demodulation reference signal ports for transmitting a plurality of codewords, receiving the plurality of codewords, or a combination thereof. In certain embodiments, the method 600 includes determining 604 a set of demodulation reference signal ports of the plurality of demodulation reference signal ports for each codeword of the plurality of codewords based on a demodulation reference signal group configuration. In some embodiments, the method 600 includes receiving 606 second information indicating a plurality of reference signals for transmitting the plurality of codewords, receiving the plurality of codewords, or a combination thereof.

In certain embodiments, the first information indicates an entry in a table corresponding to a plurality of antenna ports. In some embodiments, the table is selected from a plurality of tables based on a demodulation reference signal configuration, a transmission rank, or a combination thereof. In various embodiments, the entry in the table is selected based on the demodulation reference signal group configuration, a transmission rank of each codeword, or a combination thereof.

In one embodiment, a demodulation reference signal group of a plurality of demodulation reference signal groups indicated by the demodulation reference signal group configuration comprises at least one code division multiplexed group of a plurality of code division multiplexed groups. In certain embodiments, each code division multiplexed group of the plurality of code division multiplexed groups corresponds to one demodulation reference signal group of a plurality of demodulation reference signal groups.

In some embodiments, the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

In various embodiments, a first code division multiplexed group of the plurality of code division multiplexed groups is assigned to the first demodulation reference signal group, and a second code division multiplexed group of the plurality of code division multiplexed groups is assigned to the second demodulation reference signal group. In one embodiment, a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

In certain embodiments, a demodulation reference signal group indicated by the demodulation reference signal group configuration corresponds to one transmission reception point of a plurality of transmission reception points, one panel of a plurality of panels, or a combination thereof. In some embodiments, the one panel comprises a panel identifier. In various embodiments, the panel identifier is used as a demodulation reference signal group identifier.

In one embodiment, a demodulation reference signal group identifier is associated with a panel identifier by higher layer parameters. In certain embodiments, the second information is indicated by a plurality of sounding reference signal resource indicators or transmission configuration indicator states. In some embodiments, each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

In various embodiments, each transmission configuration indicator state of the plurality of transmission configuration indicator states comprises a least one reference signal of the plurality of reference signals, and the at least one reference signal is quasi co-located with one demodulation reference signal group for downlink reception.

In one embodiment, a method comprises: transmitting downlink control information, wherein the downlink control information comprises first information used to indicate a plurality of demodulation reference signal ports for transmitting a plurality of codewords, receiving the plurality of codewords, or a combination thereof; and transmitting second information indicating a plurality of reference signals for transmitting the plurality of codewords, receiving the plurality of codewords, or a combination thereof.

In certain embodiments, the first information indicates an entry in a table corresponding to a plurality of antenna ports.

In some embodiments, the table is selected from a plurality of tables based on a demodulation reference signal configuration, a transmission rank, or a combination thereof.

In various embodiments, the entry in the table is selected based on a demodulation reference signal group configuration, a transmission rank of each codeword, or a combination thereof.

In one embodiment, a demodulation reference signal group of a plurality of demodulation reference signal groups indicated by the demodulation reference signal group configuration comprises at least one code division multiplexed group of a plurality of code division multiplexed groups.

In certain embodiments, each code division multiplexed group of the plurality of code division multiplexed groups corresponds to one demodulation reference signal group of a plurality of demodulation reference signal groups.

In some embodiments, the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

In various embodiments, a first code division multiplexed group of the plurality of code division multiplexed groups is assigned to the first demodulation reference signal group, and a second code division multiplexed group of the plurality of code division multiplexed groups is assigned to the second demodulation reference signal group.

In one embodiment, a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

In certain embodiments, a demodulation reference signal group indicated by the demodulation reference signal group configuration corresponds to one transmission reception point of a plurality of transmission reception points, one panel of a plurality of panels, or a combination thereof.

In some embodiments, the one panel comprises a panel identifier.

In various embodiments, the panel identifier is used as a demodulation reference signal group identifier.

In one embodiment, a demodulation reference signal group identifier is associated with a panel identifier by higher layer parameters.

In certain embodiments, the second information is indicated by a plurality of sounding reference signal resource indicators or transmission configuration indicator states.

In some embodiments, each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

In various embodiments, each transmission configuration indicator state of the plurality of transmission configuration indicator states comprises a least one reference signal of the plurality of reference signals, and the at least one reference signal is quasi co-located with one demodulation reference signal group for downlink reception.

In one embodiment, an apparatus comprises: a transmitter that: transmits downlink control information, wherein the downlink control information comprises first information used to indicate a plurality of demodulation reference signal ports for transmitting a plurality of codewords, receiving the plurality of codewords, or a combination thereof; and transmits second information indicating a plurality of reference signals for transmitting the plurality of codewords, receiving the plurality of codewords, or a combination thereof.

In certain embodiments, the first information indicates an entry in a table corresponding to a plurality of antenna ports.

In some embodiments, the table is selected from a plurality of tables based on a demodulation reference signal configuration, a transmission rank, or a combination thereof.

In various embodiments, the entry in the table is selected based on a demodulation reference signal group configuration, a transmission rank of each codeword, or a combination thereof.

In one embodiment, a demodulation reference signal group of a plurality of demodulation reference signal groups indicated by the demodulation reference signal group configuration comprises at least one code division multiplexed group of a plurality of code division multiplexed groups.

In certain embodiments, each code division multiplexed group of the plurality of code division multiplexed groups corresponds to one demodulation reference signal group of a plurality of demodulation reference signal groups.

In some embodiments, the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

In various embodiments, a first code division multiplexed group of the plurality of code division multiplexed groups is assigned to the first demodulation reference signal group, and a second code division multiplexed group of the plurality of code division multiplexed groups is assigned to the second demodulation reference signal group.

In one embodiment, a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

In certain embodiments, a demodulation reference signal group indicated by the demodulation reference signal group configuration corresponds to one transmission reception point of a plurality of transmission reception points, one panel of a plurality of panels, or a combination thereof.

In some embodiments, the one panel comprises a panel identifier.

In various embodiments, the panel identifier is used as a demodulation reference signal group identifier.

In one embodiment, a demodulation reference signal group identifier is associated with a panel identifier by higher layer parameters.

In certain embodiments, the second information is indicated by a plurality of sounding reference signal resource indicators or transmission configuration indicator states.

In some embodiments, each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

In various embodiments, each transmission configuration indicator state of the plurality of transmission configuration indicator states comprises a least one reference signal of the plurality of reference signals, and the at least one reference signal is quasi co-located with one demodulation reference signal group for downlink reception.

In one embodiment, a method comprises: receiving downlink control information, wherein the downlink control information comprises first information used to indicate a plurality of demodulation reference signal ports for transmitting a plurality of codewords, receiving the plurality of codewords, or a combination thereof; determining a set of demodulation reference signal ports of the plurality of demodulation reference signal ports for each codeword of the plurality of codewords based on a demodulation reference signal group configuration; and receiving second information indicating a plurality of reference signals for transmitting the plurality of codewords, receiving the plurality of codewords, or a combination thereof.

In certain embodiments, the first information indicates an entry in a table corresponding to a plurality of antenna ports.

In some embodiments, the table is selected from a plurality of tables based on a demodulation reference signal configuration, a transmission rank, or a combination thereof.

In various embodiments, the entry in the table is selected based on the demodulation reference signal group configuration, a transmission rank of each codeword, or a combination thereof.

In one embodiment, a demodulation reference signal group of a plurality of demodulation reference signal groups indicated by the demodulation reference signal group configuration comprises at least one code division multiplexed group of a plurality of code division multiplexed groups.

In certain embodiments, each code division multiplexed group of the plurality of code division multiplexed groups corresponds to one demodulation reference signal group of a plurality of demodulation reference signal groups.

In some embodiments, the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

In various embodiments, a first code division multiplexed group of the plurality of code division multiplexed groups is assigned to the first demodulation reference signal group, and a second code division multiplexed group of the plurality of code division multiplexed groups is assigned to the second demodulation reference signal group.

In one embodiment, a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

In certain embodiments, a demodulation reference signal group indicated by the demodulation reference signal group configuration corresponds to one transmission reception point of a plurality of transmission reception points, one panel of a plurality of panels, or a combination thereof.

In some embodiments, the one panel comprises a panel identifier.

In various embodiments, the panel identifier is used as a demodulation reference signal group identifier.

In one embodiment, a demodulation reference signal group identifier is associated with a panel identifier by higher layer parameters.

In certain embodiments, the second information is indicated by a plurality of sounding reference signal resource indicators or transmission configuration indicator states.

In some embodiments, each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

In various embodiments, each transmission configuration indicator state of the plurality of transmission configuration indicator states comprises a least one reference signal of the plurality of reference signals, and the at least one reference signal is quasi co-located with one demodulation reference signal group for downlink reception.

In one embodiment, an apparatus comprises: a receiver that receives downlink control information, wherein the downlink control information comprises first information used to indicate a plurality of demodulation reference signal ports for transmitting a plurality of codewords, receiving the plurality of codewords, or a combination thereof; and a processor that determines a set of demodulation reference signal ports of the plurality of demodulation reference signal ports for each codeword of the plurality of codewords based on a demodulation reference signal group configuration; wherein the receiver receives second information indicating a plurality of reference signals for transmitting the plurality of codewords, receiving the plurality of codewords, or a combination thereof.

In certain embodiments, the first information indicates an entry in a table corresponding to a plurality of antenna ports.

In some embodiments, the table is selected from a plurality of tables based on a demodulation reference signal configuration, a transmission rank, or a combination thereof.

In various embodiments, the entry in the table is selected based on the demodulation reference signal group configuration, a transmission rank of each codeword, or a combination thereof.

In one embodiment, a demodulation reference signal group of a plurality of demodulation reference signal groups indicated by the demodulation reference signal group configuration comprises at least one code division multiplexed group of a plurality of code division multiplexed groups.

In certain embodiments, each code division multiplexed group of the plurality of code division multiplexed groups corresponds to one demodulation reference signal group of a plurality of demodulation reference signal groups.

In some embodiments, the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

In various embodiments, a first code division multiplexed group of the plurality of code division multiplexed groups is assigned to the first demodulation reference signal group, and a second code division multiplexed group of the plurality of code division multiplexed groups is assigned to the second demodulation reference signal group.

In one embodiment, a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

In certain embodiments, a demodulation reference signal group indicated by the demodulation reference signal group configuration corresponds to one transmission reception point of a plurality of transmission reception points, one panel of a plurality of panels, or a combination thereof.

In some embodiments, the one panel comprises a panel identifier.

In various embodiments, the panel identifier is used as a demodulation reference signal group identifier.

In one embodiment, a demodulation reference signal group identifier is associated with a panel identifier by higher layer parameters.

In certain embodiments, the second information is indicated by a plurality of sounding reference signal resource indicators or transmission configuration indicator states.

In some embodiments, each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

In various embodiments, each transmission configuration indicator state of the plurality of transmission configuration indicator states comprises a least one reference signal of the plurality of reference signals, and the at least one reference signal is quasi co-located with one demodulation reference signal group for downlink reception.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
transmitting a demodulation reference signal group configuration comprising at least one code division multiplexed group of a plurality of code division multiplexed groups;
transmitting downlink control information, wherein the downlink control information comprises first information used to indicate a plurality of demodulation reference signal ports for transmitting a plurality of codewords based on the demodulation reference signal group configuration, receiving the plurality of codewords, or a combination thereof; and
transmitting second information indicating a plurality of reference signals for transmitting the plurality of codewords, receiving the plurality of codewords, or a combination thereof.

2. (canceled)

3. (canceled)

4. (canceled)

5. (canceled)

6. (canceled)

7. The method of claim 5, wherein the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

8. The method of claim 7, wherein a first code division multiplexed group of the plurality of code division multiplexed groups is assigned to the first demodulation reference signal group, and a second code division multiplexed group of the plurality of code division multiplexed groups is assigned to the second demodulation reference signal group.

9. The method of claim 4, wherein a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

10. The method of claim 4, wherein a demodulation reference signal group indicated by the demodulation reference signal group configuration corresponds to one transmission reception point of a plurality of transmission reception points, one panel of a plurality of panels, or a combination thereof.

11. The method of claim 10, wherein the one panel comprises a panel identifier and the panel identifier is used as a demodulation reference signal group identifier.

12. (canceled)

13. (canceled)

14. The method of claim 1, wherein the second information is indicated by a plurality of sounding reference signal resource indicators or transmission configuration indicator states.

15. The method of claim 14, wherein each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

16. The method of claim 14, wherein each transmission configuration indicator state of the plurality of transmission configuration indicator states comprises a least one reference signal of the plurality of reference signals, and the at least one reference signal is quasi co-located with one demodulation reference signal group for downlink reception.

17. An apparatus comprising:
a transmitter that:
transmits a demodulation reference signal group configuration comprising at least one code division multiplexed group of a plurality of code division multiplexed groups;
transmits downlink control information, wherein the downlink control information comprises first information used to indicate a plurality of demodulation reference signal ports for transmitting a plurality of codewords based on the demodulation reference signal group configuration, receiving the plurality of codewords, or a combination thereof; and
transmits second information indicating a plurality of reference signals for transmitting the plurality of codewords, receiving the plurality of codewords, or a combination thereof.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A method comprising:
receiving a demodulation reference signal group configuration comprising at least one code division multiplexed group of a plurality of code division multiplexed groups;
receiving downlink control information, wherein the downlink control information comprises first information used to indicate a plurality of demodulation reference signal ports for transmitting a plurality of codewords based on the demodulation reference signal group configuration, receiving the plurality of codewords, or a combination thereof;
determining a set of demodulation reference signal ports of the plurality of demodulation reference signal ports for each codeword of the plurality of codewords based on the demodulation reference signal group configuration; and
receiving second information indicating a plurality of reference signals for transmitting the plurality of codewords, receiving the plurality of codewords, or a combination thereof.

34. (canceled)

35. (canceled)

36. (canceled)

37. (canceled)

38. (canceled)

39. The method of claim 37, wherein the downlink control information comprises at least one bit used to indicate whether a third code division multiplexed group of the plurality of code division multiplexed groups is assigned to a first demodulation reference signal group of the plurality of demodulation reference signal groups, a second demodulation reference signal group of the plurality of demodulation reference signal groups, no demodulation reference signal group of the plurality of demodulation reference signal groups, or some combination thereof.

40. The method of claim 39, wherein a first code division multiplexed group of the plurality of code division multiplexed groups is assigned to the first demodulation reference signal group, and a second code division multiplexed group of the plurality of code division multiplexed groups is assigned to the second demodulation reference signal group.

41. The method of claim 33, wherein a demodulation reference signal group indicated by the demodulation reference signal group configuration comprises a set of demodulation reference signal ports of the plurality of demodulation reference signal ports, and each demodulation reference signal port of the set of demodulation reference signal ports is quasi co-located with other demodulation reference signal ports of the set of demodulation reference signal ports.

42. The method of claim 33, wherein a demodulation reference signal group indicated by the demodulation reference signal group configuration corresponds to one transmission reception point of a plurality of transmission reception points, one panel of a plurality of panels, or a combination thereof.

43. The method of claim 42, wherein the one panel comprises a panel identifier.

44. The method of claim 43, wherein the panel identifier is used as a demodulation reference signal group identifier.

45. (canceled)

46. The method of claim 33, wherein the second information is indicated by a plurality of sounding reference signal resource indicators or transmission configuration indicator states.

47. The method of claim 46, wherein each sounding reference signal resource indicator of the plurality of sounding reference signal resource indicators comprises at least one reference signal of the plurality of reference signals, and a target demodulation reference signal is transmitted with a spatial domain transmission filter indicated by a corresponding sounding reference signal resource indicator.

48. The method of claim 46, wherein each transmission configuration indicator state of the plurality of transmission configuration indicator states comprises a least one reference signal of the plurality of reference signals, and the at least one reference signal is quasi co-located with one demodulation reference signal group for downlink reception.

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)
